(19) United States
(12) Patent Application Publication
(10) Pub. No.: US 2010/0162688 A1
(43) Pub. Date: Jul. 1, 2010

(54) FUEL INJECTION APPARATUS

(76) Inventors: Jen-Shin Chang, Hamilton (CA); Hirohito Hirata, Shizuoka (JP); Masaru Kakinohana, Shizuoka (JP); Masaya Ibe, Shizuoka (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/594,977

(22) PCT Filed: Apr. 11, 2008
(86) PCT No.: PCT/JP2008/057555

§ 371 Date: Mar. 19, 2010

(30) Foreign Application Priority Data
Apr. 11, 2007 (JP) 2007-103735

(51) Int. Cl. F01N 9/00; F02M 51/00; F01N 3/10

(52) U.S. Cl. 60/286; 239/585.1; 60/299; 60/303

(57) ABSTRACT

A fuel injection apparatus (31) comprises an EHD atomizer (32). The EHD atomizer (32) comprises a cylindrical body (33) and a narrow pipe (34) attached to a tip of the cylindrical body (33). The cylindrical body (33) is connected through a fuel introducing pipe (35) to a fuel tank (36), and an electronically-controlled fuel pump (37) is arranged in the fuel introducing pipe (35). A voltage application device (38) is electrically connected to the narrow pipe (34). When the fuel is to be injected, the fuel pump (37) is operated to supply the fuel in the fuel tank (36) through the fuel introducing pipe (35) into the cylindrical body (33) of the EHD atomizer (32). The fuel is then flown through the narrow pipe (34) and is injected from the tip of the narrow pipe (34). At this time, the voltage application device (38) applies a pulse voltage or applies a pulse voltage and a direct-current voltage superimposingly to the narrow pipe (34).

### TECHNICAL FIELD

The present invention relates to a fuel injection apparatus.

### BACKGROUND ART

A fuel injection apparatus which injects fuel (hydrocarbon) into an engine intake passage or an engine combustion chamber for supplying the fuel to the combustion chamber, or which injects the fuel into an engine exhaust passage for supplying the fuel, as a reducing agent, to a catalyst arranged in the exhaust passage, has been conventionally known.

In these cases, as a matter of course, efficient use of the fuel is preferable, and as a means therefor, atomization of the injected fuel is known. Further, reformation, such as lightening of the fuel is also effective for the efficient use of the fuel because the reactivity of the fuel can be increased.

However, in order to use the fuel even more efficiently, simultaneously carrying out atomization and reformation of the fuel is necessary.

### DISCLOSURE OF THE INVENTION

Therefore, the object of the present invention is to provide a fuel injection apparatus which can simultaneously carry out atomization and reformation of the fuel, to thereby use the fuel more effectively.

According to a first aspect of the present invention, there is provided a fuel injection apparatus comprising a fuel injection pipe to which a voltage application means is connected, wherein fuel is flown through the fuel injection pipe while a pulse voltage is applied to the fuel injection pipe, to thereby inject the fuel while the pulse voltage is applied to the fuel.

In addition, according to a second aspect of the present invention, there is provided an exhaust gas purification apparatus for an internal combustion engine, comprising:

a NOx absorbent arranged in an engine exhaust passage, the NOx absorbent absorbing NOx in an exhaust gas when an air-fuel ratio of the inflowing exhaust gas is lean and releasing the absorbed NOx when the air-fuel ratio of the inflowing exhaust gas is rich; and

an fuel injection device arranged in the engine exhaust passage on the upstream side of the NOx absorbent, from which fuel is injected to temporally make the air-fuel ratio of the exhaust gas flowing into the NOx absorbent rich when NOx is to be released from the NOx absorbent,

wherein the fuel injection device comprises a fuel injection pipe to which a voltage application means is connected, and wherein fuel is flown through the fuel injection pipe while a pulse voltage is applied to the fuel injection pipe, to thereby inject the fuel while the pulse voltage is applied to the fuel.

### BRIEF DESCRIPTION OF THE DRAWINGS

FIG. 1 is an overall view of the fuel injection apparatus.

FIG. 2 is a time chart showing the voltage application pattern of a pulse application injection.

FIG. 3 is a time chart showing the voltage application pattern of a superimposed application injection.

FIG. 4 is a time chart showing the voltage application pattern of a direct current application injection.

FIG. 5 shows the experimental equipment.

FIGS. 6A and 6B show the experimental results.

FIG. 7 shows an overall view of an internal combustion engine when the present invention is applied for supplying fuel to a catalyst.

FIGS. 8A and 8B are cross-sectional views of a surface portion of a catalyst carrier.

FIG. 9 is a map showing the amount of NOx absorbed per unit time dNOx.

FIG. 10 is a time chart explaining the fuel addition timing.

FIG. 11 is a time chart showing the voltage application pattern.

FIG. 12 is a flowchart showing the NOx release control routine according to a first embodiment of the present invention.

FIG. 13 shows the experimental equipment.

FIG. 14 shows the experimental results.

FIG. 15 is a view explaining the second embodiment of the present invention.

FIGS. 16 and 17 are flowcharts showing a NOx release control routine according to the second embodiment of the present invention.

FIGS. 18 and 19 show the third embodiment of the present invention.

FIG. 20 shows the experimental equipment.

FIG. 21 shows the experimental results.

FIGS. 22 and 23 show the fourth embodiment of the present invention.

FIG. 24 shows the fifth embodiment of the present invention.

FIG. 25 shows the sixth embodiment of the present invention.

FIG. 26 is a flowchart showing the deposit removal routine.

FIG. 27 shows the seventh embodiment of the present invention.

FIG. 28 is a time chart explaining the seventh embodiment of the present invention.

FIG. 29 is a flowchart showing a NOx release control routine according to the seventh embodiment of the present invention.

FIG. 30 shows the experimental equipment.

FIG. 31 shows the experimental results.

FIGS. 32A and 32B are overall views of an internal combustion engine when the present invention is applied for supplying fuel to the internal combustion engine.

### BEST MODE FOR CARRYING OUT THE INVENTION

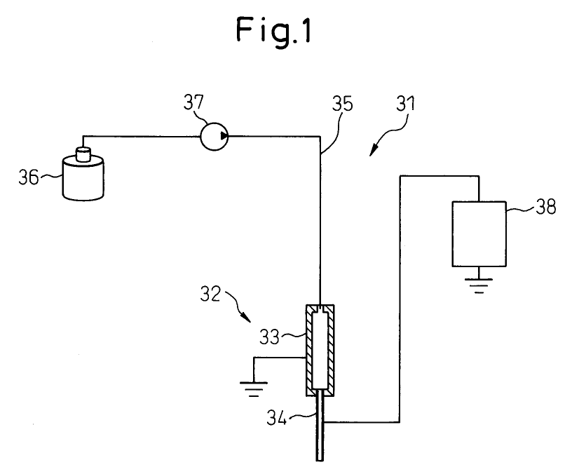

Referring to FIG. 1, a fuel injection apparatus 31 is provided with a fuel injection nozzle or an EHD atomizer 32. The EHD atomizer 32 comprises a cylindrical body 33 made of an insulation material such as ceramic, and a fuel injection pipe 34 made of an electrically-conductive material such as metal and attached to a tip of the cylindrical body 33. In an embodiment of the present invention, the fuel injection pipe 34 is composed of a narrow pipe or a capillary. The cylindrical body 33 is connected to a fuel tank 36 through a fuel introducing pipe 35, and an electronically-controlled fuel pump 37 is arranged in the fuel introducing pipe 35. On the other hand, a voltage application device 38 is electrically connected to the narrow pipe 34. The cylindrical body 33 is grounded so as not to be electrically charged.

The fuel can be composed of liquid hydrocarbon, for example, gasoline, light oil, alcohol, and the like.

When the fuel is to be injected, the fuel pump 37 is operated to supply the fuel in the fuel tank 36 to the cylindrical body 33 of the EHD atomizer 32 through the fuel introducing pipe 35. Then, the fuel is flown through the narrow pipe 34 and is injected from the tip of the narrow pipe 34, and at this time, a voltage is applied to the narrow pipe 34 by a voltage application device 38. Generally, an EHD injection in which fuel is flown through the narrow pipe 34 while a voltage is applied to the narrow pipe 34, to thereby inject the fuel while the voltage is applied to the fuel, is carried out.

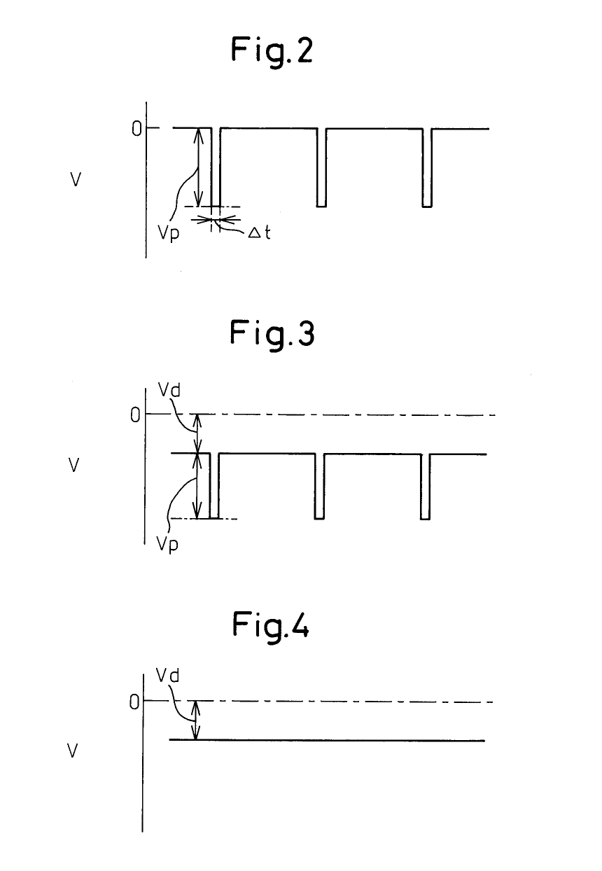

FIG. 2 shows a voltage application pattern according to an embodiment of the present invention. In the embodiment shown in FIG. 2, the voltage application device 38 comprises a pulse power source, and a pulse voltage Vp is repeatedly applied to the fuel. Namely, the applied voltage V is set to the pulse voltage Vp (<0) at a constant cycle and is maintained at the pulse voltage Vp during the very short voltage maintaining time Δt.

The inventors of the present application have confirmed that when the pulse voltage is applied to the fuel, both the reforming action and the atomizing action of the fuel can be obtained simultaneously.

There are unclear points with regards to the reformation and atomization mechanism of the fuel of this case, but the mechanism is roughly considered as follows. Namely, when the pulse voltage Vp is applied to the fuel, the applied voltage V changes from zero to Vp, and in the meantime, a chemical bond of the fuel (hydrocarbon) molecule is cut by the current or the electrons flowing in the fuel. As a result, for example, the number of carbon molecules constituting the straight-chain hydrocarbon becomes fewer, a multiple bond becomes a single bond, ring-opening of the annular hydrocarbon occurs, or hydrogen is generated, to thereby reform the fuel. On the other hand, during the voltage maintaining time Δt that the applied voltage V is maintained at the pulse voltage Vp, the fuel is electrically charged to the same polarity, and the fuel droplets are atomized by the electric repulsion force generated in the fuel, similar to the case that the direct-current voltage is applied to the fuel. Accordingly, the fuel is supplied with energy, and thus, the reforming action and the atomizing action of the fuel can be obtained simultaneously. This is the basic idea of the present invention.

FIG. 3 shows a voltage application pattern according to another embodiment of the present invention. In the embodiment shown in FIG. 3, the voltage application device 38 comprises a pulse power source and a direct-current power source, and the pulse voltage Vp (<0) and the direct-current voltage Vd (<0) are superimposingly applied to the fuel.

According to the above-mentioned fuel reformation and atomization mechanism, when a voltage is steadily applied to the fuel, the fuel is electrically charged to promote the fuel atomizing action. Therefore, in the case that the pulse voltage and the direct-current voltage are superimposingly applied to the fuel, the time period that the voltage is steadily applied to fuel becomes longer compared to the case of the pulse application injection. Thus, the amount of electric charge to the fuel becomes larger, and the electric repulsion force generated in the fuel becomes larger. Thereby, atomization of the fuel is further promoted.

Further, when the direct-current voltage Vd is superimposingly applied with the pulse voltage Vp, the peak value of the applied voltage becomes Vp+Vd, and the fuel is supplied with energy to an extent which is almost the same as the case when only the pulse voltage (Vp+Vd) is applied. Therefore, the fuel reforming action can be further promoted compared to the case where only the pulse voltage Vp is applied.

Hereinafter, the fuel injection mode where the fuel is injected while only the pulse voltage is applied to the fuel, as shown in FIG. 2, is referred to as a pulse application injection. The fuel injection mode where the fuel is injected while the pulse voltage and the direct-current voltage are superimposingly applied to the fuel, as shown in FIG. 3, is referred to as a superimposed application injection. In addition, the fuel injection mode where the fuel is injected while only the direct-current voltage Vd is applied to the fuel, as shown in FIG. 4, is referred to as a direct current application injection. The fuel injection mode where the fuel is injected while no voltage is applied to the fuel is referred to as a non-application injection.

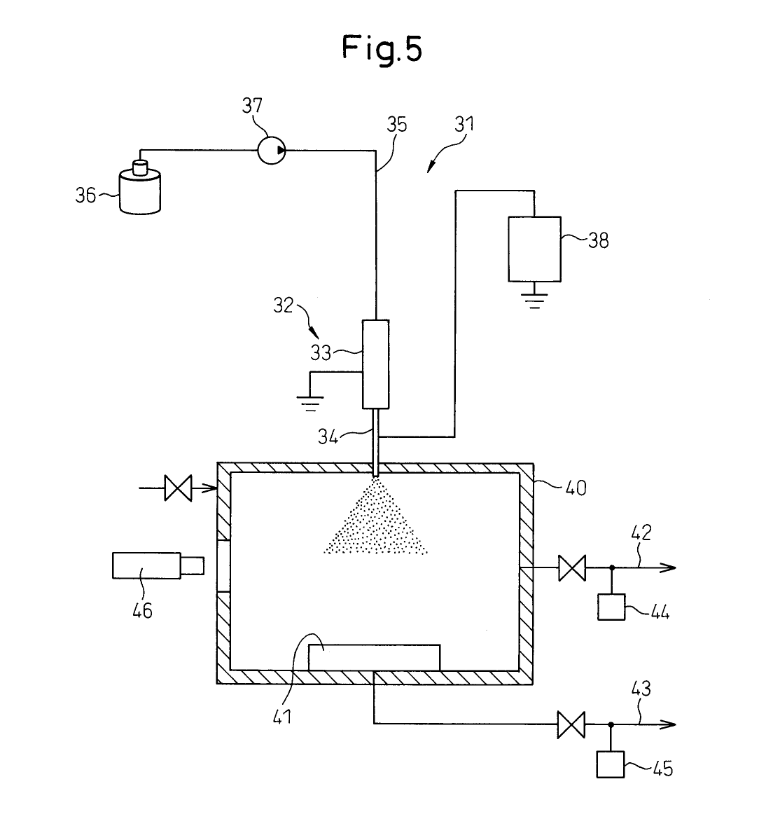

The good fuel reforming and atomizing action obtained when the pulse application injection and the superimposed application injection are performed is supported by an experiment. FIG. 5 shows the equipment used for the experiment. Referring to FIG. 5, an EHD atomizer 32 is attached to the top of a chamber 40 made of an insulation material, and a tray 41 is arranged at a bottom of the inside of the chamber 40. In addition, a sampling line 42 for sampling from a gas phase in the chamber 40 and a sampling line 43 for sampling a liquid phase in the tray 41 are connected to the chamber 40, and analyzers 44 and 45 are connected to these sampling lines 42 and 43, respectively. Further, a high-speed infrared imaging camera (minimum resolution 100 μm) 46 for observing the inside of the chamber 40 is provided.

The cylindrical body 33 of the EHD atomizer 32 was made of an alumina tube, and the narrow pipe 34 thereof was formed by a stainless needle (length 2.5 cm, diameter 1.7 mm). In addition, n-decane (C₁₀H₂₂) was used as the fuel. The fuel was continuously supplied to the EHD atomizer 32 at 6 ml/sec, and the pulse application injection, the superimposed application injection, and the non-application injection were performed. In the case of the pulse application injection, −25 kV, −28 kV, and −30 kV (current was 3 to 20 mA, frequency was 50 to 200 Hz) were used as the pulse voltage Vp. In the case of the superimposed application injection, −30 kV was used as the pulse voltage Vp, and −15 kV was used as the direct-current voltage Vd. For these cases, samples obtained from the gas phase and the liquid phase in the chamber 40 were subjected to component analyses, respectively, and the reformation rates (=amount of reformed fuel/amount of injected fuel) were measured. Further, the injected fuel was observed by the camera 46.

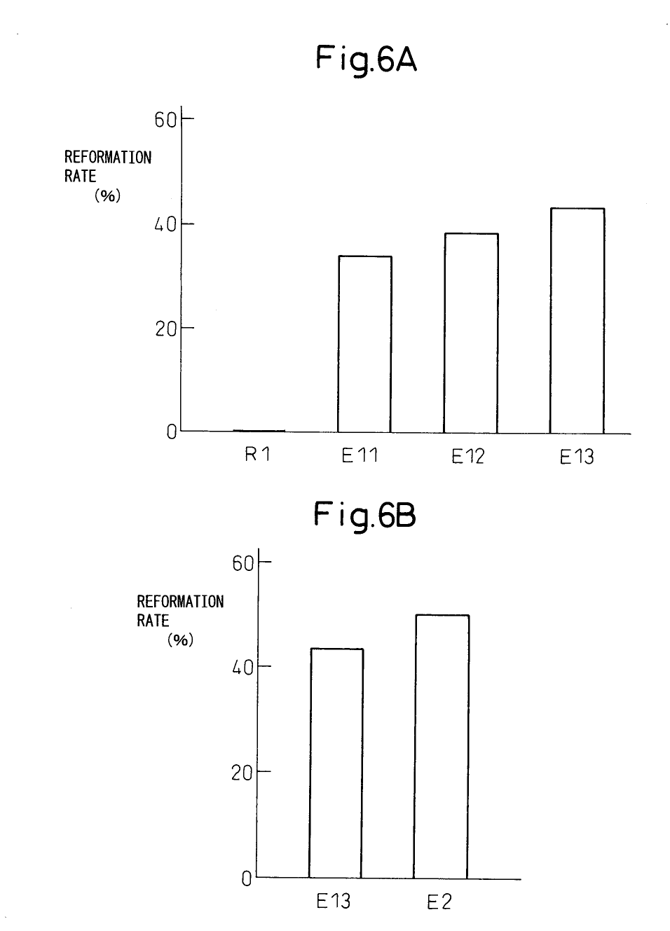

FIGS. 6A and 6B show the experimental results of the reformation rate. In FIGS. 6A and 6B, R1 represents the case of the non-application injection, E11, E12, and E13 respectively represent the cases of the pulse application injection wherein the pulse voltage is −25 kV, −28 kV, and −30 kV, and E2 represents the case of the superimposed application injection, respectively.

As shown in FIG. 6A, in the case of the pulse application injection (E11, E12, and E13), a good fuel reforming action was confirmed. It was also confirmed that the larger the pulse voltage Vp, the higher the reformation rate. In contrast, in the case of the non-application injection (R1), almost no fuel reforming action could be confirmed. In addition, in the case of the pulse application injection, it was confirmed by the image taken by the camera that the fuel was atomized to the order of μm. In contrast, in the case of the non-application injection, a fuel droplet merely drops from the narrow pipe 4, and almost no fuel atomizing action could be observed.

Further, as shown in FIG. 6B, it was confirmed that in the case of the superimposed application injection (E2), the fuel reforming action could be promote more than the case of the pulse application injection (E13) using the same pulse voltage Vp.

The present invention can be applied to various uses. For example, the present invention can be applied for supplying the fuel (hydrocarbon) to the catalyst arranged in the exhaust passage of the internal combustion engine, and supplying the fuel to the combustion chamber of the internal combustion engine.

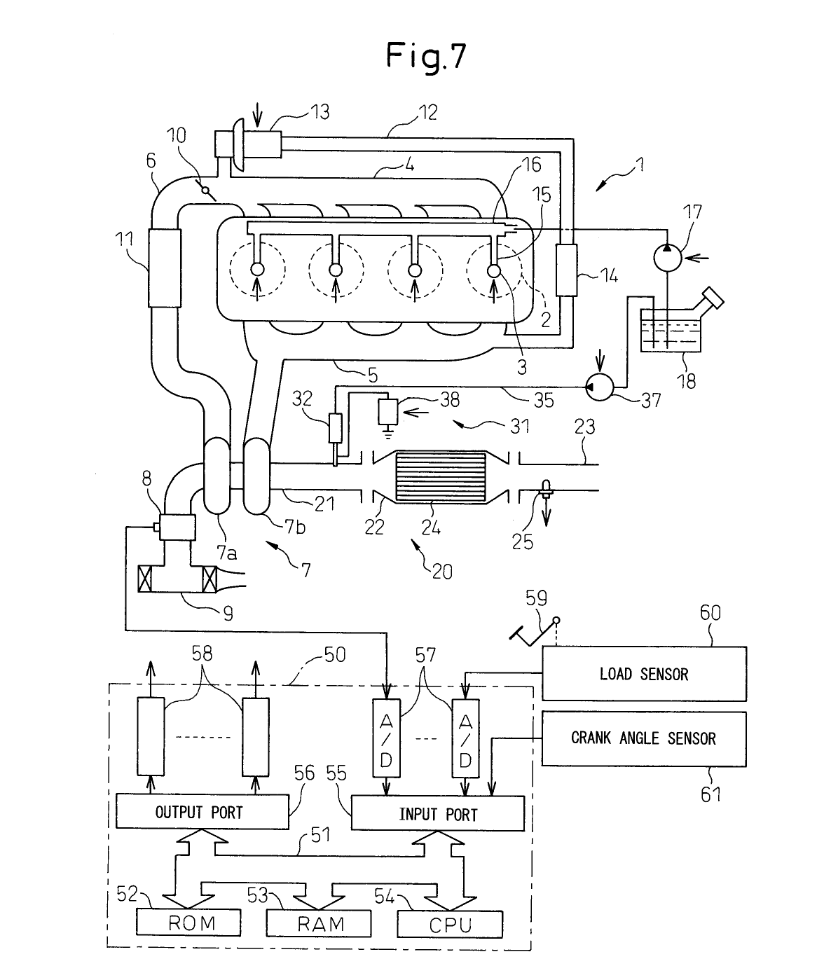

FIG. 7 shows a first embodiment in the case where the present invention is applied to fuel addition to a catalyst arranged in an exhaust passage of an internal combustion engine of a compression ignition type. Of course, the present invention can be applied to fuel addition to a catalyst of an internal combustion engine of a spark ignition type.

Referring to FIG. 7, 1 indicates an engine body, 2 a combustion chamber of each cylinder, 3 an electronically controlled fuel injector for injecting fuel into each combustion chamber 2, 4 an intake manifold, and 5 an exhaust manifold. The intake manifold 4 is connected through an intake duct 6 to an outlet of a compressor 7a of an exhaust turbocharger 7. The inlet of the compressor 7a is connected to an air cleaner 9 through an air flow meter 8. Inside the intake duct 6 an electronically controlled throttle valve 10 is arranged. Further, around the intake duct 6 a cooling device 11 for cooling the intake air flowing through the inside of the intake duct 6 is arranged. In the embodiment shown in FIG. 7, the engine cooling water is guided into the cooling device 11. The engine cooling water cools the intake air. On the other hand, the exhaust manifold 5 is connected to an inlet of an exhaust turbine 7b of the exhaust turbocharger 7, while the outlet of the exhaust turbine 7b is connected to an exhaust aftertreatment system 20.

The exhaust manifold 5 and the intake manifold 4 are interconnected through an exhaust gas recirculation (hereinafter referred to as an “EGR”) passage 12. Inside the EGR passage 12 is arranged an electronically controlled EGR control valve 13. Further, around the EGR passage 12 a cooling device 14 is arranged for cooling the EGR gas flowing through the inside of the EGR passage 12. In the embodiment shown in FIG. 7, the engine cooling water is guided into the cooling device 14. The engine cooling water cools the EGR gas. On the other hand, each fuel injector 3 is connected through a fuel feed tube 15 to a common rail 16. This common rail 16 is connected to a fuel tank 18 through an electronically controlled variable discharge fuel pump 17. The fuel, such as gas oil, in the fuel tank 18 is supplied into the common rail 16 by the fuel pump 17, the fuel supplied into the common rail 16 is supplied through each fuel feed tube 15 to the fuel injector 3.

The exhaust aftertreatment system 20 comprises an exhaust pipe 21 connected to the outlet of the exhaust turbine 7b, a catalytic converter 22 connected to the exhaust pipe 21, and an exhaust pipe 23 connected to the catalytic converter 22. A NOx storing and reducing catalyst 24 is arranged in the catalytic converter 22. In addition, a temperature sensor 25 for detecting the temperature of the exhaust gas discharging from the catalytic converter 22. The temperature of the exhaust gas discharging from the catalytic converter 22 represents the temperature of the NOx storing and reducing catalyst 24.

Further, the fuel injection apparatus 31 shown in FIG. 1 is attached to the exhaust pipe 21. The EHD atomizer 32 of the fuel injection apparatus 31 is connected to the fuel tank 18 through the fuel introducing pipe 35, and the fuel pump 37 is arranged in the fuel introducing pipe 35. In the embodiment shown in FIG. 7, when the addition from the EHD atomizer 32 into the exhaust pipe 21 is to be carried out, the fuel pump 37 is operated, and the fuel is added from the EHD atomizer 32 to the exhaust pipe 21 in the amount same as the amount of the fuel discharged from the fuel pump 37. In addition, the voltage application device 38 is provided with the pulse power source and the direct-current power source so that one or both of the pulse voltage and the direct-current voltage can be applied to the fuel. Alternatively, the fuel injection apparatus 31 can be attached to an exhaust manifold 5.

An electronic control unit 50 is comprised of a digital computer provided with a read only memory (ROM) 52, a random access memory (RAM) 53, a microprocessor (CPU) 54, an input port 55, and an output port 56 all connected to each other by a bidirectional bus 51. The output signals of the air flow meter 8 and temperature sensor 25 are input through corresponding AD converters 57 to the input port 55. Further, an accelerator pedal 59 has a load sensor 60 generating an output voltage proportional to the amount of depression L of the accelerator pedal 59 connected to it. The output voltage of the load sensor 60 is input through a corresponding AD converter 57 to the input port 55. Further, the input port 55 has a crank angle sensor 61 generating an output pulse each time the crankshaft turns for example by 15 degrees connected to it. On the other hand, the output port 56 is connected through corresponding drive circuits 58 to the fuel injectors 3, driver for the throttle valve 10, EGR control valve 13, fuel pumps 17, 37, and voltage application device 38.

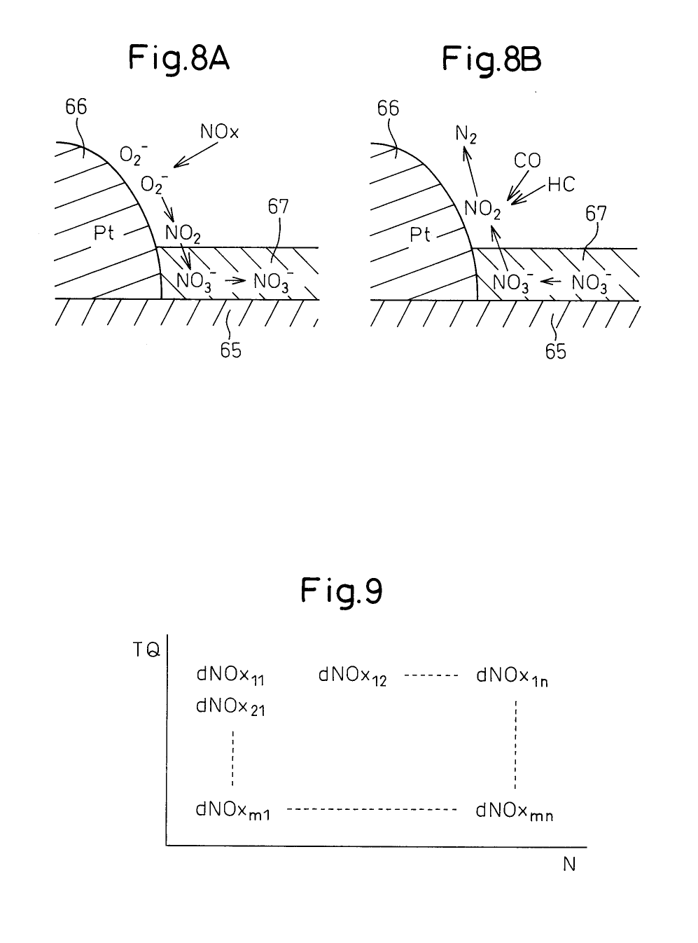

In the embodiment shown in FIG. 7, the NOx storing and reducing catalyst 24 forms a honeycomb structure and is provided with a plurality of exhaust gas passages separated from each other by partitions. The opposite surfaces of the partitions carry a catalyst carrier comprised of, for example, alumina. FIGS. 8A and 8B schematically show the cross-section of the surface part of this catalyst carrier 65. As shown in FIGS. 8A and 8B, the catalyst carrier 65 carries a precious metal catalyst 66 diffused on its surface. Further, the catalyst carrier 65 is formed with a layer of a NOx absorbent 67 on its surface. Further, in the embodiment shown in FIGS. 7, 8A and 8B, platinum Pt is used as the precious metal catalyst 66. As the ingredient forming the NOx absorbent 67, for example, at least one element selected from potassium K, sodium Na, cesium Cs, or another alkali metal, barium Ba, calcium Ca, or another alkali earth, lanthanum La, yttrium Y, or another rare earth may be used. Note that the NOx storing and reducing catalyst 24 may be carried on a particulate filter for trapping particulates contained in the exhaust gas.

If the ratio of the air and fuel (hydrocarbons) supplied to the engine intake passage, combustion chambers 2, and exhaust passage upstream of the NOx storing and reducing catalyst 24 is referred to as an air-fuel ratio of the exhaust gas, the NOx absorbent 67 performs an NOx absorption and release action of absorbing the NOx when the air-fuel ratio of the exhaust gas is lean and releasing the absorbed NOx when the oxygen concentration in the exhaust gas falls.

That is, taking as an example the case of using barium Ba as the ingredient forming the NOx absorbent 67, when the air-fuel ratio of the exhaust gas is lean, that is, when the oxygen concentration in the exhaust gas is high, the NO contained in the exhaust gas is oxidized on the platinum Pt 66 such as shown in FIG. 8A to become NO₂, then is absorbed in the NOx absorbent 67 and diffuses in the NOx absorbent 67 in the form of nitric acid ions NO₃⁻ while bonding with the barium carbonate BaCO₃. In this way, the NOx is absorbed in the NOx absorbent 67. So long as the oxygen concentration in the exhaust gas is high, NO₂ is produced on the surface of the platinum Pt 66. So long as the NOx absorbing capability of the NOx absorbent 67 is not saturated, the NO₂ is absorbed in the NOx absorbent 67 and nitric acid ions NO₃⁻ are produced.

As opposed to this, when the air-fuel ratio of the exhaust gas is made rich or the stoichiometric air-fuel ratio, since the oxygen concentration in the exhaust gas falls, the reaction proceeds in the reverse direction (NO₃⁻->NO₂) and therefore the nitric acid ions NO₃⁻ in the NOx absorbent 67 are released from the NOx absorbent 67 in the form of NO₂. The released NOx is then reduced by the unburned HC or CO contained in the exhaust gas.

In the engine shown in FIG. 7, combustion under a lean air-fuel ratio is continued, and the air-fuel ratio of the exhaust gas inflowing the NOx absorbent 67 is thus maintained lean so long as fuel addition from the EHD atomizer 32 is kept stopped. The NOx contained in the exhaust gas is absorbed in the NOx absorbent 67 at this time. However, if combustion under a lean air-fuel ratio is continued, the NOx absorbing capability of the NOx absorbent 67 will end up becoming saturated and therefore NOx will end up no longer being able to be absorbed by the NOx absorbent 67. Therefore, in the first embodiment according to the present invention, before the absorbing capability of the NOx absorbent 67 becomes saturated, fuel is supplied from the EHD atomizer 32 so as to temporarily make the air-fuel ratio of the exhaust gas rich and thereby release the NOx from the NOx absorbent 67.

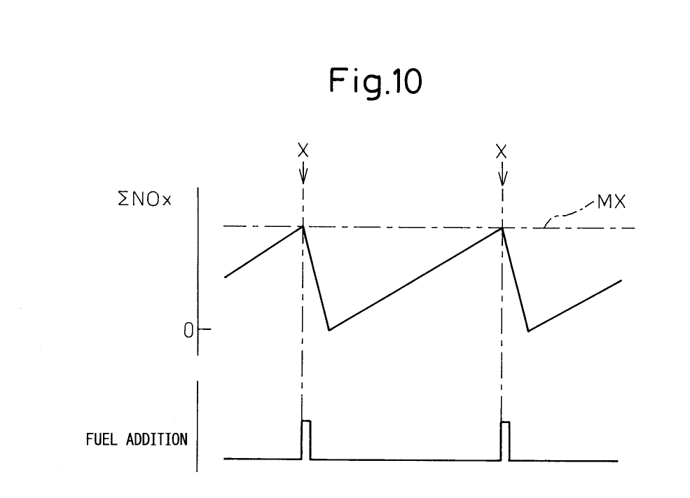

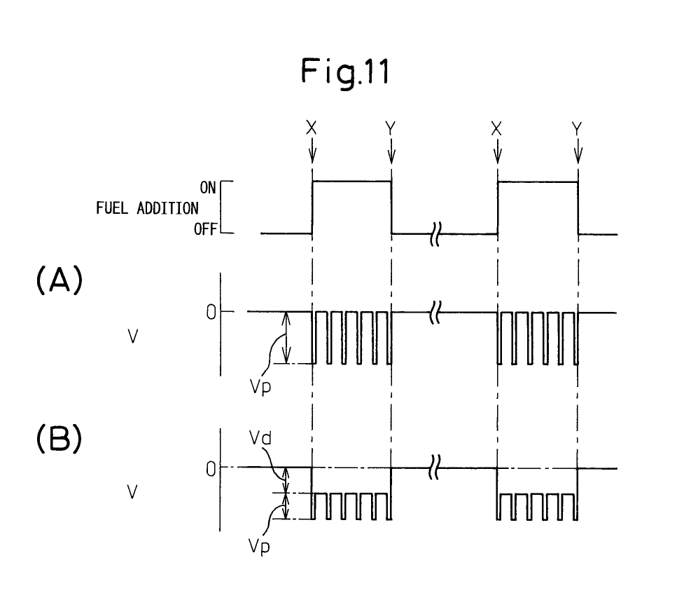

Namely, in the first embodiment of the present invention, the amount of NOx absorbed in a NOx absorbent 67 per unit time dNOx has been previously stored in a ROM 52 in the form of a map as shown in FIG. 9 as a function of the target torque TQ and the engine revolution number N. The cumulative value ΣNOx of the amount of NOx absorbed in the NOx absorbent 67 is calculated by cumulating this NOx amount dNOx. Then, as shown by X in FIG. 10, every time when the NOx amount cumulative value ΣNOx exceeds the allowable value MX, the fuel is added from the EHD atomizer 32 to the exhaust pipe 21, to thereby temporally switch the air-fuel ratio of the exhaust gas flowing into the NOx absorbent 67 to rich. As a result, NOx is released from the NOx absorbent 67 and reduced.

In this case, according to the first embodiment of the present invention, the pulse application injection or the superimposed application injection is performed at the EHD atomizer 32. Namely, in the case of the pulse application injection, as shown in (A) in FIG. 11, during the period between time point X and time point Y, the fuel is added while the pulse voltage Vp is repeatedly applied. On the other hand, in the case of the superimposed application injection, as shown in (B) in FIG. 11, during the period from time point X and time point Y, the fuel is added while the direct-current voltage Vd is applied and the pulse voltage Vp is repeatedly applied.

When the pulse application injection or the superimposed application injection is performed, as mentioned above, the fuel reforming and atomizing actions can be obtained simultaneously. Accordingly, the fuel having a high reactivity can be supplied to the NOx storing and reducing catalyst 24, and thus, the exhaust purification performance of the NOx storing and reducing catalyst 24 can be improved. Further, since the amount of the fuel consumed in the NOx storing and reducing catalyst 24 is increased, the amount of fuel emitting from the NOx storing and reducing catalyst 24 can be decreased. Accordingly, the fuel can be effectively used for the exhaust purifying action.

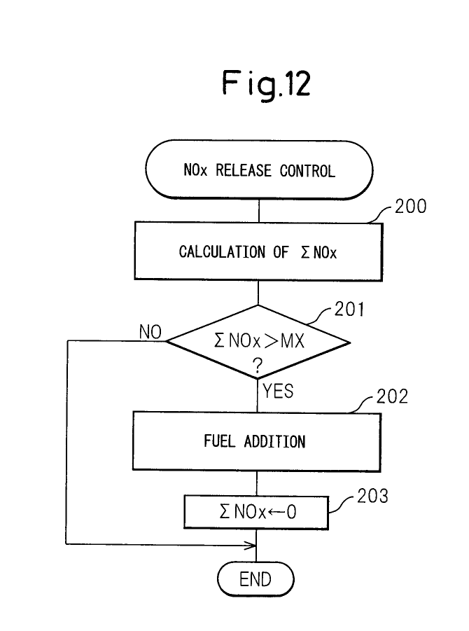

FIG. 12 shows an NOx release control routine according to the first embodiment of the present invention. This routine is performed by interrupting at every previously determined set time.

Referring to FIG. 12, at first, the NOx amount cumulative value ΣNOx is calculated in Step 200 (ΣNOx=ΣNOx+dNOx). In the subsequent Step 201, whether or not the NOx amount cumulative value ΣNOx exceeds the allowable value MX is judged. When ΣNOx≦MX, the processing cycle is terminated. When ΣNOx>MX, the process proceeds to the subsequent Step 202 to carry out fuel addition by performing the pulse application injection or the superimposed application injection at the EHD atomizer 32. In the subsequent Step 203, the NOx amount cumulative value ΣNOx is cleared (ΣNOx=0).

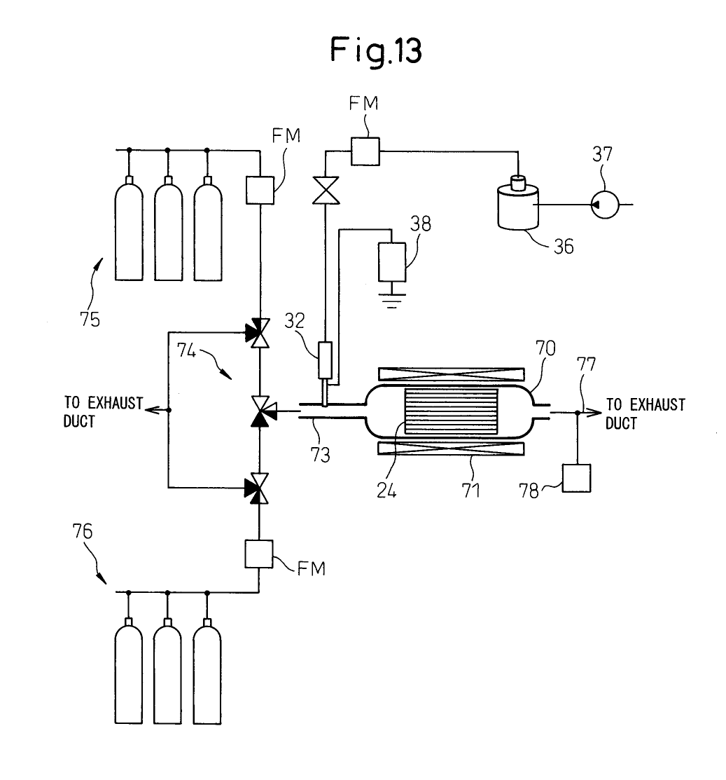

The good exhaust purification performance of the NOx storing and reducing catalyst 24 when the pulse application injection or the superimposed application injection is performed is supported by the experiment. FIG. 13 shows the equipment used for the experiment. Referring to FIG. 13, the NOx storing and reducing catalyst 24 is housed in a quartz tube 70, and the quartz tube 70 is housed in an electric furnace 71. The quartz tube 70 is provided therein with a temperature sensor (not shown) for detecting the internal temperature thereof. The output of the electric furnace 71 is controlled so that the internal temperature of the quartz tube 70, namely, the temperature of the catalyst reaches the targeted temperature. An introducing pipe 73 is connected to an inlet of the quartz tube 70, and a lean gas line 75 or a rich gas line 76 is selectively connected to the introducing pipe 73 through a valve device 74. In addition, the EHD atomizer 32 is attached to the introducing pipe 73. On the other hand, an exhaust pipe 77 is connected to an outlet of the quartz tube 70, and an analyzer 78 is connected to the exhaust pipe 77. Note that, in FIG. 13, FM represents a flow meter.

In the present experiment, a dinitrodiamine platinum solution (platinum: 4.4%) and barium acetate were used to form the NOx storing and reducing catalyst 24 which carries barium: 0.2 mol and platinum 2 wt % for 100 g of commercially available γ-Al₂O₃. Further, C₈H₁₈ was used as the fuel added from the EHD atomizer 32.

At first, the following pretreatment was performed. Namely, while only N₂ is supplied into the quartz tube 70, the catalyst temperature was increased to 450° C. by 10° C./min. Then, while the catalyst temperature is maintained at 450° C., the reduction treatment was performed by supplying a reducing gas (H₂: 1%, N₂: balance) for 15 minutes. Subsequently, while only N₂ is supplied into the quartz tube 70, the catalyst temperature was decreased to 300° C. by 10° C./min.

Next, a simulated lean gas was supplied from the lean gas line 75 into the quartz tube 70 at 15 liter/min. The composition of the simulated lean gas was O₂: 8%, NO: 200 ppm, H₂O: 3%, and N₂: balance. Then, when the NO concentration of the exhaust gas from the quartz tube 70 became substantially equal to the NO concentration (200 ppm) of the simulated lean gas, in other words, when the NOx storing and reducing catalyst 24 or the NOx absorbent 67 was saturated, the gas which was supplied to the quartz tube 70 was switched to the simulated rich gas. At the time that the simulated rich gas was to be supplied, the gas having a composition of NO: 200 ppm, H₂O: 3%, and N₂: balance was supplied from the rich gas line 76, and at the same time, C₈H₁₈ was added from the EHD atomizer 32 at 4.4 cc/min. The simulated rich gas was supplied at 15 liter/min for 30 seconds. In this case, the non-application injection, the direct current application injection, and the superimposed application injection were carried out at the EHD atomizer 32, and the storage NOx amount SNOx was obtained for respective cases.

The storage NOx amount SNOx (mol-NO/g-cat) is obtained by measuring the amount of NOx stored in the NOx storing and reducing catalyst 24 when the gas supplied to the quartz tube 70 is switched from the simulated rich gas to the simulated lean gas, and the simulated lean gas is supplied until the NOx storing and reducing catalyst 24 is saturated again, and by standardizing the measured value per 1 gram of the NOx storing and reducing catalyst. This storage NOx amount SNOx is substantially equal to the amount of NOx released from the NOx storing and reducing catalyst 24 and reduced when the simulated rich gas is supplied, and accordingly, represents the exhaust purification performance of the NOx storing and reducing catalyst 24. On the other hand, when the fuel added from the EHD atomizer 32 has high reactivity, a larger amount of NOx is released from the NOx storing and reducing catalyst 24 and reduced. Accordingly, it can be considered that the storage NOx amount SNOx represents the reactivity of the added fuel. Note that the amount of NOx stored in the NOx storing and reducing catalyst 24 when the simulated lean gas is supplied can be obtained by, for example, detecting the NO concentration of the exhaust gas when the simulated lean gas is supplied, and time-integrating the difference between this NO concentration and the NO concentration of the simulated lean gas until the saturation of the NOx storing and reducing catalyst 24.

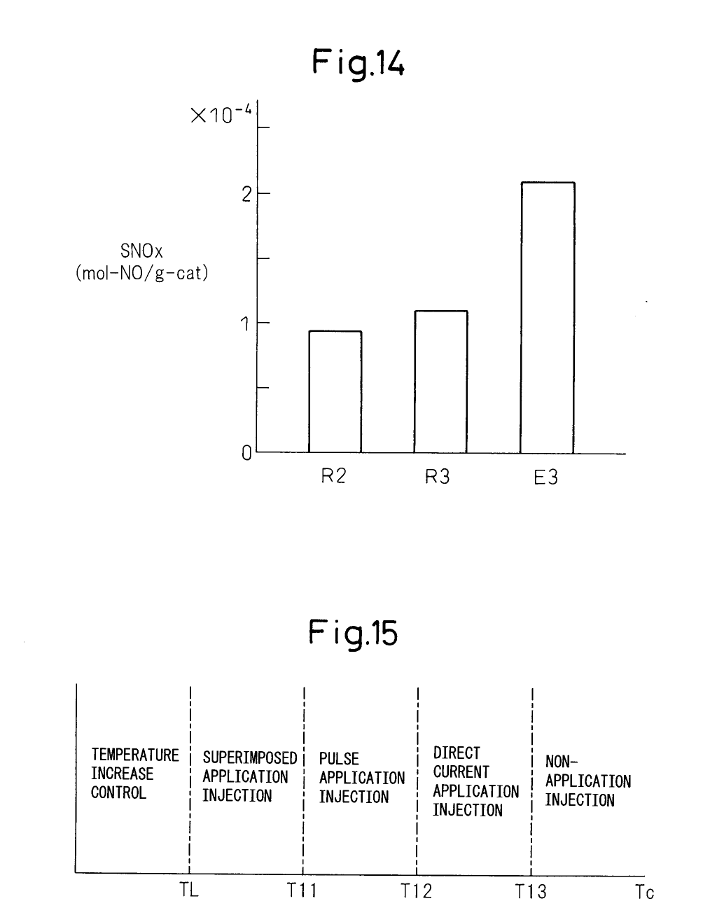

FIG. 14 shows the experimental results of the storage NOx amount SNOx. In FIG. 14, R2 shows the case when the non-application injection was carried out while the simulated rich gas was supplied, R3 shows the case when the direct current application injection was carried out, and E3 shows the case when the superimposed application injection was carried out, respectively. As shown in FIG. 14, in the case of the superimposed application injection (E3), the storage NOx amount SNOx is large, compared to the cases of the non-application injection (R2) and the direct current application injection (R3), and accordingly, the exhaust purification performance of the NOx storing and reducing catalyst 24 can be increased.

Next, a second embodiment of the present invention will be explained.

As can be understood from the explanation so far, the extent of the fuel reforming and atomizing action, namely, the reactivity of the fuel varies depending on the fuel injection mode of the EHD atomizer 32. That is to say, the reactivity increases in the order of the non-application injection, the direct current application injection, the pulse application injection, and the superimposed application injection. However, the energy consumption associated with the voltage application to the fuel increases in this order. On the other hand, when the temperature of the NOx storing and reducing catalyst 24 or the NOx absorbent 67, namely, the catalyst temperature Tc is low, increase of the reactivity of the fuel by applying voltage to the fuel is necessary, but when the catalyst temperature Tc is high, this is not always necessary.

Then, according to the second embodiment of the present invention, the fuel injection mode of the EHD atomizer 32 is selectively switched depending on the catalyst temperature Tc. Specifically, as shown in FIG. 15, when the catalyst temperature Tc is lower than the first switching temperature T11, the superimposed application injection is performed. When the catalyst temperature Tc is higher than the first switching temperature T11 but lower than the second switching temperature T12 (>T11), the pulse application injection is performed. When the catalyst temperature Tc is higher than the second switching temperature T12 but lower than the third switching temperature T13 (>T12), the direct current application injection is performed. When the catalyst temperature Tc is higher than the third switching temperature T13, the non-application injection is performed.

T11 represents a temperature at which the exhaust purification performance of the NOx storing and reducing catalyst 24 is the allowable lower limit when the pulse application injection is performed. T12 represents a temperature at which the exhaust purification performance of the NOx storing and reducing catalyst 24 is the allowable lower limit when the direct current application injection is performed. T13 represents a temperature at which the exhaust purification performance of the NOx storing and reducing catalyst 24 is the allowable lower limit when the non-application injection is performed.

Therefore, while the energy consumption associated with the voltage application to the fuel decreases, the fuel added to the NOx storing and reducing catalyst 24 can be effectively utilized for the NOx emission.

In addition, according to the second embodiment of the present invention, as shown in FIG. 15, when the catalyst temperature Tc is lower than the allowable lower limit temperature TL, the fuel addition from the EHD atomizer 32 is prohibited, and the temperature increase control is performed for increasing the catalyst temperature Tc while the air-fuel ratio of the exhaust gas flowing into the NOx storing and reducing catalyst 24 is maintained to lean. This is because, when the catalyst temperature Tc is lower than the allowable lower limit temperature TL, even if the fuel is added from the EHD atomizer 32 to the NOx storing and reducing catalyst 24, it is possible that the fuel is hardly consumed in the NOx storing and reducing catalyst 24, but is emitted from the NOx storing and reducing catalyst 24. The temperature increase control is carried out by, for example, increasing the fuel injection amount from the fuel injection valve 3, to thereby increase the temperature of the exhaust gas flowing into the NOx storing and reducing catalyst 24.

Accordingly, speaking in generalization, the pulse application injection and the direct current application injection are selectively switched, or the pulse application injection and the non-application injection are selectively switched. It can also be said that the superimposed application injection and the pulse application injection are selectively switched, or the superimposed application injection and the direct current application injection are selectively switched, or the superimposed application injection and the non-application injection are selectively switched.

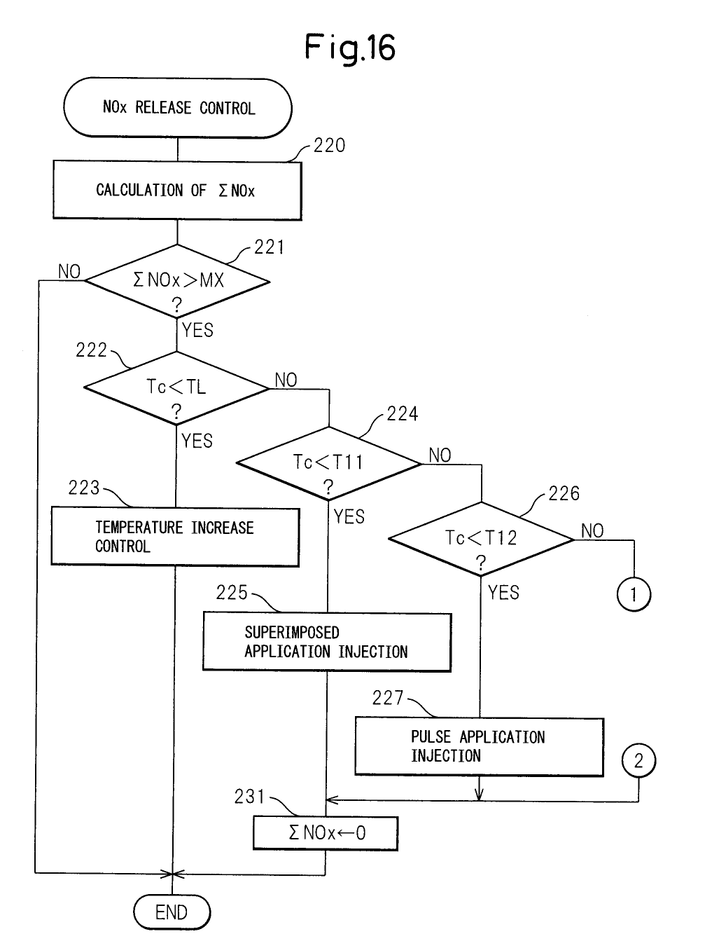

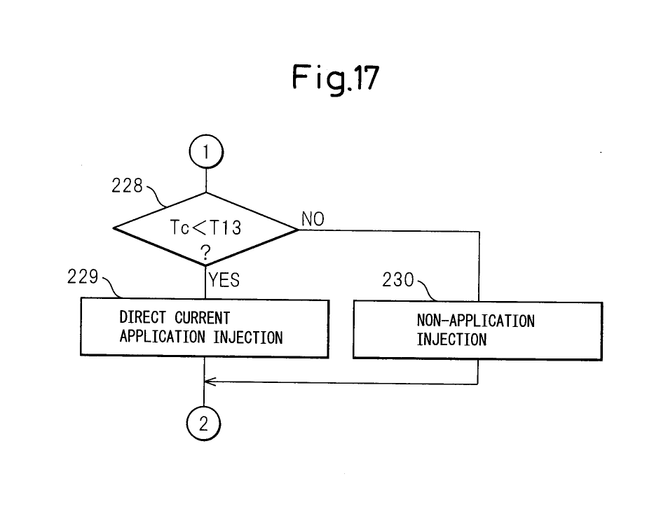

FIG. 16 and FIG. 17 show an NOx release control routine according to the second embodiment of the present invention. This routine is performed by interrupting at every previously determined set time.

Referring to FIG. 16 and FIG. 17, at first, the NOx amount cumulative value ΣNOx is calculated in Step 220 (ΣNOx=ΣNOx+dNOx). In the subsequent Step 221, whether or not the NOx amount cumulative value ΣNOx exceeds the allowable value MX is judged. When ΣNOx≦MX, the processing cycle is terminated. When ΣNOx>MX, the process proceeds to the subsequent Step 222, and whether or not the catalyst temperature Tc is lower than the allowable lower limit temperature TL is judged. When Tc<TL, the process proceeds to the subsequent Step 223 and the temperature increase control is performed. In contrast, when Tc≧TL, the process proceeds from Step 222 to Step 224, and whether or not the catalyst temperature Tc is lower than the first switching temperature T11 is judged. When Tc<T11, namely, when TL≦Tc<T11, the process proceeds to Step 225, and the superimposed application injection is performed. Then, the process proceeds to Step 231. In contrast, when Tc≧T11, the process proceeds from Step 224 to Step 226, and whether or not the catalyst temperature Tc is lower than the second switching temperature T12 is judged. When Tc<T12, namely, T11≦Tc<T12, the process proceeds to the subsequent Step 227, and the pulse application injection is performed. Then, the process proceeds to Step 231. In contrast, when Tc≧T12, the process proceeds from Step 226 to Step 228, and whether or not the catalyst temperature Tc is lower than the third switching temperature T13 is judged. When Tc<T13, namely, when T12≦Tc<T13, the process proceeds to Step 229, and the direct current application injection is performed. Then, the process proceeds to Step 231. In contrast, when Tc≧T13, the process proceeds from Step 228 to Step 230, and the non-application injection is performed. Then, the process proceeds to Step 231. In Step 231, the NOx amount cumulative value ΣNOx is cleared (ΣNOx=0).

As mentioned above, according to the second embodiment of the present invention, the fuel injection mode is selectively switched depending on the temperature Tc of the NOx storing and reducing catalyst 24. However, the fuel injection mode can be selectively switched depending on, for example, the pressure around the NOx storing and reducing catalyst 24, or the amount of a specific component in the exhaust gas flowing into the NOx storing and reducing catalyst 24 or the exhaust gas flowing out from the NOx storing and reducing catalyst 24. In other words, the fuel injection mode can be selectively switched depending on the state quantity of the NOx storing and reducing catalyst 24.

Alternatively, as mentioned above, the present invention can be applied for the fuel supply into the engine combustion chamber. In this case, the fuel injection mode can be selectively switched depending on the engine temperature such as the temperature of the engine cooling water. For example, when the temperature of the engine cooling water is low, the superimposed application injection is performed. As the temperature of the engine cooling water increases, the injection mode is to be sequentially switched to the pulse application injection, the direct current application injection, and the non-application injection in this order. Thereby, good combustion can be obtained, while the amount of unburned HC emitted from the combustion chamber is decreased.

Accordingly, speaking in generalization, the fuel injection mode is selectively switched depending on the state quantity of the fuel supply destination.

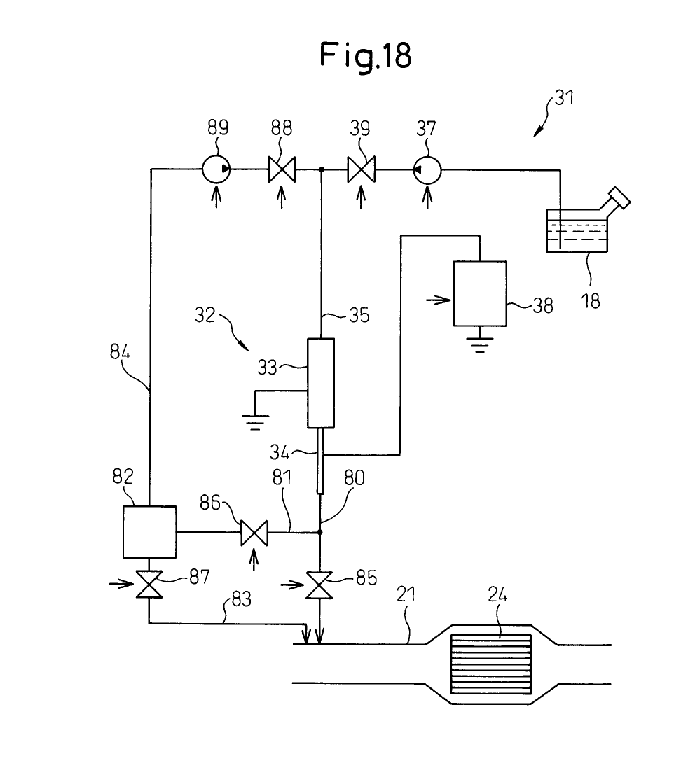

Next, a third embodiment of the present invention will be explained with reference to FIG. 18.

Referring to FIG. 18, an electronically-controlled open/close valve 39 is arranged in the fuel introducing pipe 35 located between the fuel pump 37 and the EHD atomizer 32. In addition, a fuel addition pipe 80 is connected to the tip of the narrow pipe 34 of the EHD atomizer 32. From the fuel addition pipe 80, a fuel pipe 81 is branched, and the fuel pipe 81 is connected to a storage chamber 82. The storage chamber 82 is connected, on the one hand, to the fuel addition pipe 83, and is connected, on the other hand, through the fuel circulation pipe 84 to the fuel introducing pipe 35 located between the open/close valve 39 and the EHD atomizer 32. Electronically-controlled open/close valves 85, 86, 87, and 88 are respectively arranged in the portion the fuel addition pipe 80 located on the downstream side of the portion where the fuel pipe 81 is branched, in the fuel pipe 81, in the fuel addition pipe 83, and in the fuel circulation pipe 84. Further, an electronically-controlled fuel pump 89 is also arranged in the fuel circulation pipe 84.

When the fuel pump 37 is operated while the open/close valves 39 and 85 are opened and the open/close valves 86, 87, and 88 are closed, the fuel in the fuel tank 18 is flown through the EHD atomizer 32, and then, is injected or added into the exhaust pipe 21. In this case, the fuel is flown through the narrow pipe 34 while only the pulse voltage is applied or both the pulse voltage and the direct-current voltage are superimposingly applied, so that the reformed and atomized fuel can be added to the NOx storing and reducing catalyst 24. This mode of the fuel addition is substantially equivalent to the above-mentioned pulse application injection or superimposed application injection in terms of the fuel reforming and atomizing action. Hereinafter, this mode of fuel addition is referred to as a voltage application addition. Note that the fuel may be flown through the narrow pipe 34 while no voltage is applied, and this mode of fuel addition is referred to as a non-application addition.

On the other hand, when the fuel pump 37 is operated while the open/close valves 39 and 86 are opened and the open/close valves 85, 87, and 88 are closed, the fuel in the fuel tank 18 is flown through the EHD atomizer 32, and then, is stored in the storage chamber 82. In this case, the fuel is flown through the narrow pipe 34 while only the pulse voltage is applied or both the pulse voltage and the direct-current voltage are superimposingly applied, so that the reformed fuel can be stored in the storage chamber 82. Note that the electricity has already been removed from the fuel injected from the EHD atomizer 32 until the fuel reaches the storage chamber 82, and the fuel is hardly atomized in the storage chamber 82.

Then, if the open/close valve 87 is opened while the open/close valve 85 remains closed, the reformed fuel within the storage chamber 82 is added to the NOx storing and reducing catalyst 24. Accordingly, the reformed fuel can be supplied to the NOx storing and reducing catalyst 24 at an arbitrarily determined time. Hereinafter, this mode of fuel addition is referred to as a stored fuel addition.

Alternatively, when the fuel pump 89 is operated while the open/close valves 39, 86, and 87 are closed, and the open/close valves 85 and 88 are opened, the fuel in the storage chamber 82 is flown again through the EHD atomizer 32, and then, is added to the NOx storing and reducing catalyst 24. In this case, the fuel is flown through the narrow pipe 34 while only the pulse voltage is applied or the pulse voltage and the direct-current voltage are superimposingly applied, so that the voltage application to the fuel is carried out again, enabling the addition of the further reformed and atomized fuel to the NOx storing and reducing catalyst 24. Hereinafter, this mode of fuel addition is referred to as a circulated fuel addition.

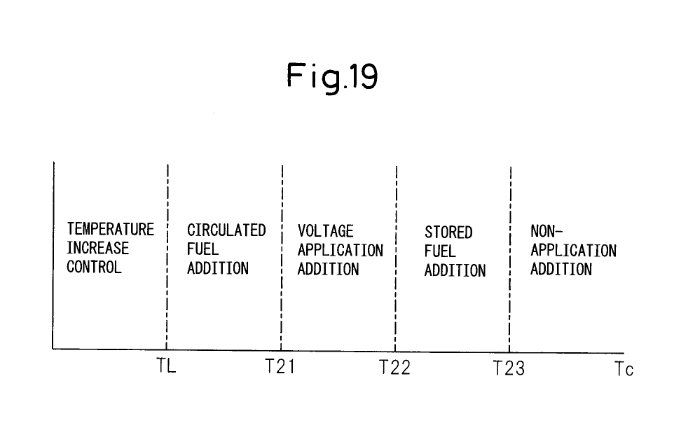

As mentioned above, according to the third embodiment of the present invention, there are various modes of fuel addition, and these fuel addition modes can be selectively switched. For example, as shown in FIG. 19, the fuel addition mode can be selectively switched depending on the catalyst temperature Tc. Namely, in the example shown in FIG. 19, when the catalyst temperature Tc is lower than the first switching temperature T21, the circulated fuel addition is performed. When the catalyst temperature Tc is higher than the first switching temperature T21, but lower than the second switching temperature T22 (>T21), the voltage application addition is performed. Further, when the catalyst temperature Tc is higher than the second switching temperature T22, but lower than the third switching temperature T23 (>T22), the stored fuel addition is performed. When the catalyst temperature Tc is higher than the third switching temperature T23, the non-application addition is performed. This is because, taking into account the extent of the fuel reforming and atomizing action, the reactivity of the added fuel increases in the order of the non-application addition, the stored fuel addition, the voltage application addition, and the circulated fuel addition.

Here, T21 represents a temperature at which the exhaust purification performance of the NOx storing and reducing catalyst 24 is the allowable lower limit when the voltage application addition is performed, T22 represents a temperature at which the exhaust purification performance of the NOx storing and reducing catalyst 24 is the allowable lower limit when the stored fuel addition is performed, and T23 represents a temperature at which the exhaust purification performance of the NOx storing and reducing catalyst 24 is the allowable lower limit when the non-application addition is performed, respectively.

Note that, in the above explanation, all of the fuel flown through the narrow pipe 34 is stored in the storage chamber 82. However, it is possible to store a part of the fuel flown through the narrow pipe 34 in the storage chamber 82 and to add the remaining fuel to the exhaust pipe 21. Accordingly, speaking in generalization, at least a part of the fuel flown through the narrow pipe 34 while the voltage is applied to the fuel is stored in the storage chamber 82, and the fuel in the storage chamber 82 is injected.

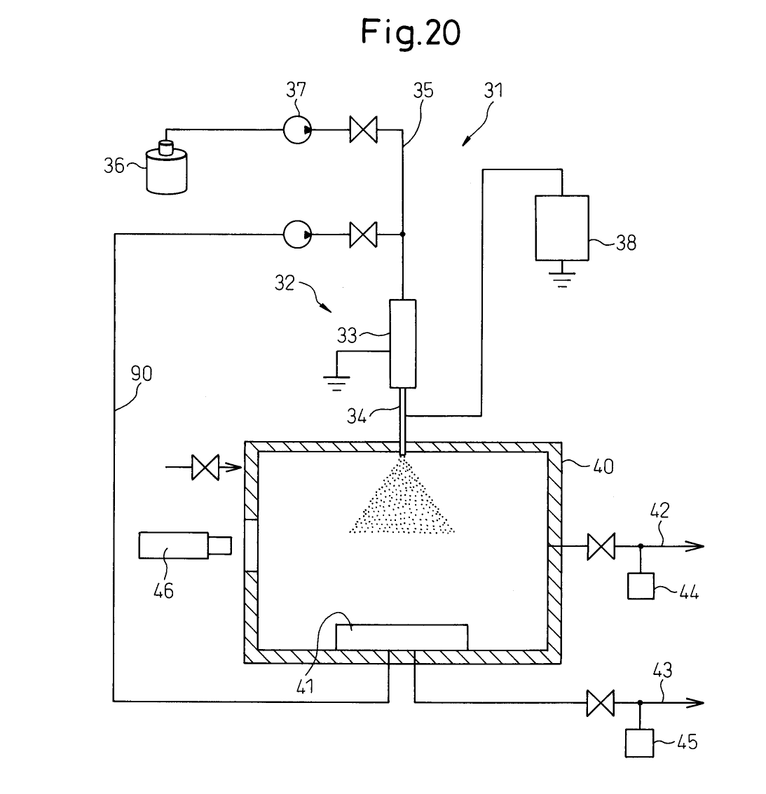

The good fuel reforming action obtained when the voltage application to the fuel is repeatedly performed, as in the circulated fuel addition, is supported by the experiment. FIG. 20 shows the equipment used for the experiment. The configuration of the present experimental equipment is different from the configuration of the experimental equipment shown in FIG. 5 in the point that according to the present experimental equipment, the fuel in the tray 41 can be supplied to the EHD atomizer 32 again through the circulation passage 90. According to the present experiment, at first, the pulse application injection was carried out for 5 minutes with the pulse voltage Vp of −30 kV, and while the fuel accumulated in the tray 41 was resupplied and circulated to the EHD atomizer 32, the pulse application injection was further carried out for 5 minutes, and then, the reformation rate was measured.

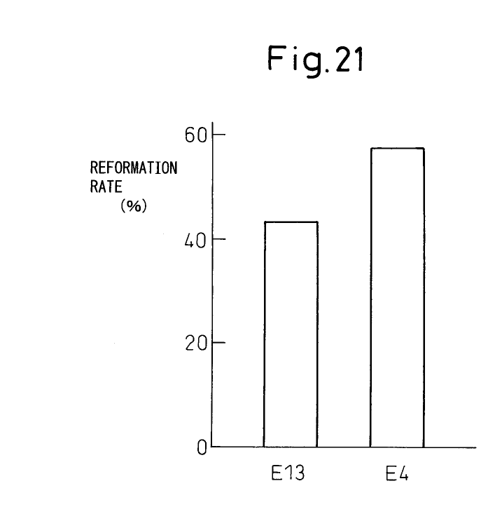

FIG. 21 shows the experimental results regarding the reformation rate. In FIG. 21, E13 shows the case when the pulse application injection was performed once, similar to FIG. 6A, and E4 shows the case when the pulse application injection is repeatedly carried out by circulating the fuel. As shown in FIG. 21, it is confirmed that by repeatedly carrying out the pulse application injection, the fuel reforming action can be promoted.

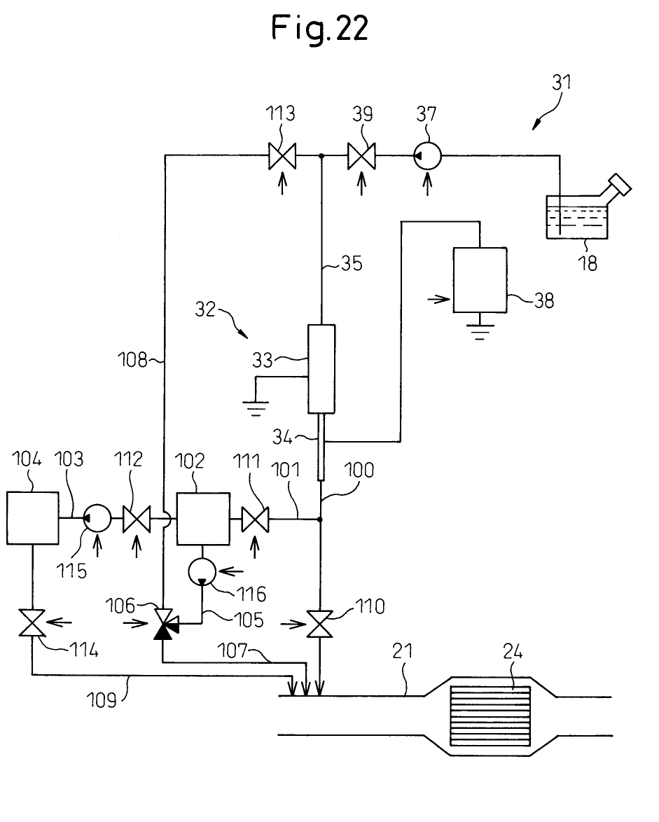

Next, a fourth embodiment of the present invention will be explained with reference to FIG. 22.

Referring to FIG. 22, a fuel addition pipe 100 is connected to a tip of the narrow pipe 34 of the EHD atomizer 32. A fuel pipe 101 is branched from the fuel addition pipe 100, and the fuel pipe 101 is connected to a liquid component chamber 102. The liquid component chamber 102 is connected, on the one hand, through a fuel pipe 103 to a gas component chamber 104, and on the other hand, through a fuel pipe 105 to a three-way valve 106. The three-way valve 106 is connected, on the one hand, to a fuel addition pipe 107, and on the other hand, through a fuel circulation pipe 108 to the fuel introducing pipe 35 located between the open/close valve 39 and the EHD atomizer 32. In addition, the gas component chamber 104 is connected to a fuel addition pipe 109. Electronically-controlled open/close valves 110, 111, 112, 113, and 114 are respectively arranged in the portion of the fuel addition pipe 100 on the downstream side of the portion where the fuel pipe 101 is branched, in the fuel pipes 101 and 103, in the fuel circulation pipe 108, and in the fuel addition pipe 109. Further, electronically-controlled fuel pumps 115 and 116 are respectively arranged in the fuel pipe 103 and the fuel pipe 105.

When the fuel pump 37 is operated while the open/close valves 39 and 110 are opened and the open/close valves 111, 113, and 114 are closed, the fuel in the fuel tank 18 is flown through the EHD atomizer 32, and is injected or added into the exhaust pipe 21. In this case, the fuel is flown through the narrow pipe 34 while only the pulse voltage is applied or the pulse voltage and the direct-current voltage are superimposingly applied, so that the reformed and atomized fuel can be added to the NOx storing and reducing catalyst 24. This mode of fuel addition is substantially equivalent to the voltage application addition according to the third embodiment of the present invention in terms of the fuel reforming and atomizing action, and is referred to as the voltage application addition also in the fourth embodiment of the present invention. Note that a non-application addition in which the fuel is flown through the narrow pipe 34 while no voltage is applied can also be performed.

On the other hand, when the fuel pump 37 is operated while the open/close valves 39 and 111 are opened and the open/close valves 110, 113, and 114 are closed, the fuel in the fuel tank 18 flows through the EHD atomizer 32, and then, flows into the liquid component chamber 102. In this case, the fuel is flown through the narrow pipe 34 while only the pulse voltage is applied or the pulse voltage and the direct-current voltage are superimposingly applied, so that the reformed fuel can be supplied into the liquid component chamber 102. Note that the electricity has already been removed from the fuel which reaches the liquid component chamber 102, and the fuel is hardly atomized. Here, when the open/close valve 112 is opened and the fuel pump 115 is operated, the gas component of the fuel in the liquid component chamber 102 flows into the gas component chamber 104, and the liquid component remains in the liquid component chamber 102. As a result, the liquid component of the reformed fuel is stored in the liquid component chamber 102, and the gas component of the reformed fuel is stored in the gas component chamber 104.

Then, when the fuel pump 116 is operated while the open/close valves 110 and 114 are closed and the liquid component chamber 102 is connected to the fuel addition pipe 107 by the three-way valve 106, the liquid component in the liquid component chamber 102 is added to the NOx storing and reducing catalyst 24. Hereinafter, this mode of fuel addition is referred to as a liquid component addition.

In contrast, when the open/close valve 114 is opened while the open/close valve 110 is closed, the gas component in the gas component chamber 104 is added to the NOx storing and reducing catalyst 24. Hereinafter, this mode of fuel addition is referred to as a gas component addition.

Alternatively, when the fuel pump 116 is operated while the open/close valves 39, 111, and 114 are closed, the open/close valves 110 and 113 are opened, and the liquid component chamber 102 is connected to the fuel circulation pipe 108 by the three-way valve 106, the liquid component in the liquid component chamber 102 is flown again through the EHD atomizer 32, and then, is added to the NOx storing and reducing catalyst 24. In this case, the fuel is flown through the narrow pipe 34 while only the pulse voltage is applied or the pulse voltage and the direct-current voltage are superimposingly applied, so that the voltage application to the fuel is performed again, and the further reformed and atomized fuel can be added to the NOx storing and reducing catalyst 24. This mode of fuel addition is substantially equivalent to the circulated fuel addition according to the third embodiment of the present invention in terms of the fuel reforming and atomizing action, and is referred to as the circulated fuel addition also in the fourth embodiment of the present invention.

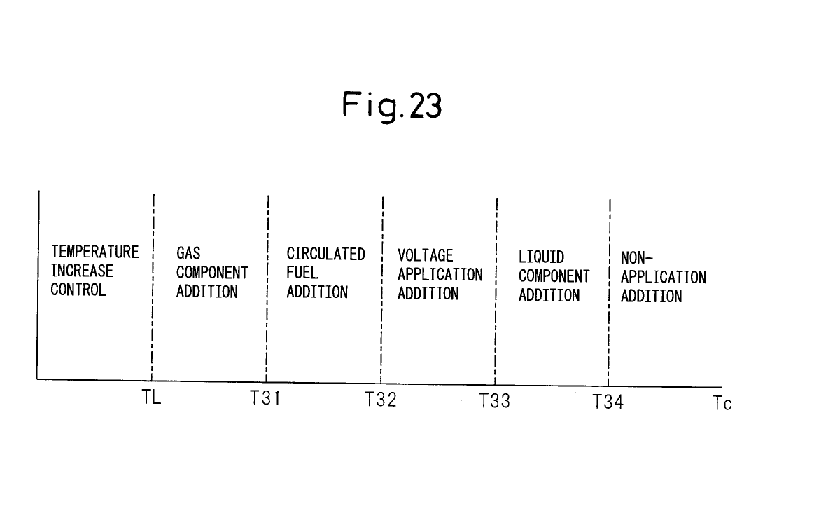

Accordingly, there are also various modes of fuel addition in the fourth embodiment of the present invention, and these fuel addition modes can be selectively switched. For example, as shown in FIG. 23, the fuel addition mode can be selectively switched depending on the catalyst temperature Tc. In the example shown in FIG. 23, when the catalyst temperature Tc is lower than the first switching temperature T31, the gas component addition is performed. When the catalyst temperature Tc is higher than the first switching temperature T31, but lower than the second switching temperature T32 (>T31), the circulated fuel addition is performed. Also, when the catalyst temperature Tc is higher than the second switching temperature T32, but lower than the third switching temperature T33 (>T32), the voltage application addition is performed. When the catalyst temperature Tc is higher than the third switching temperature T33, but lower than the fourth switching temperature T34 (>T33), the liquid component addition is performed. When the catalyst temperature Tc is higher than the fourth switching temperature T34, the non-application addition is performed. This is because the reactivity of the added fuel becomes higher in the order of the non-application addition, the liquid component addition, the voltage application addition, the circulated fuel addition, and the gas component addition.

Here, T31 represents a temperature at which the exhaust purification performance of the NOx storing and reducing catalyst 24 is the allowable lower limit when the circulated fuel addition is performed, T32 represents a temperature at which the exhaust purification performance of the NOx storing and reducing catalyst 24 is the allowable lower limit when the voltage application addition is performed, T33 represents a temperature at which the exhaust purification performance of the NOx storing and reducing catalyst 24 is the allowable lower limit when the liquid component addition is performed, and T34 represents a temperature at which the exhaust purification performance of the NOx storing and reducing catalyst 24 is the allowable lower limit when the non-application addition is performed, respectively.

In the fourth embodiment of the present invention, it is also possible to store a part of the fuel flown through the narrow pipe 34 in the liquid component chamber 102 or the gas component chamber 104, and to add the remaining fuel to the exhaust pipe 21. Accordingly, speaking in generalization, a plurality of storage chambers 102 and 104 are provided, at least a part of the fuel flown through the narrow pipe 34 while the voltage is applied to the fuel is separated and stored in the respective corresponding storage chambers 102 and 104 depending on the properties of the fuel, and the fuels in the storage chambers 102 and 104 are injected.

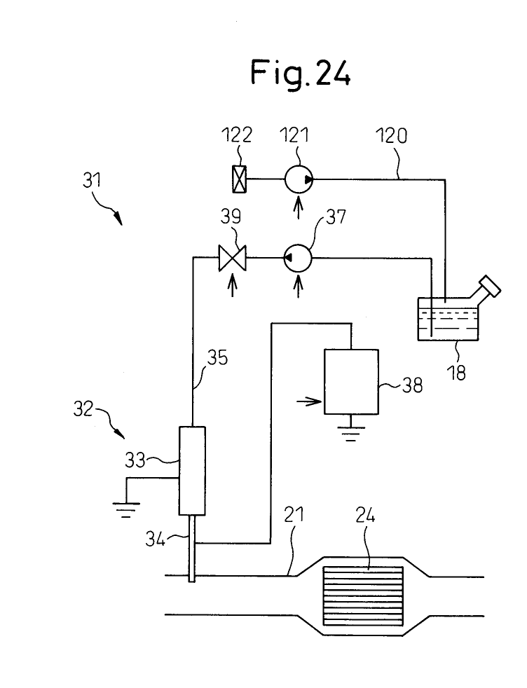

Next, a fifth embodiment of the present invention will be explained with reference to FIG. 24.

Referring to FIG. 24, an air introducing pipe 120 is connected to the fuel tank 18, and an electronically-controlled air pump 121 and an air cleaner 122 are arranged in the air introducing pipe 120. When the air pump 121 is operated, the air discharged from the air pump 121 is forced to the fuel tank 18. As a result, oxygen in the air is mixed with or dissolved in the fuel (hydrocarbon), to thereby form oxygen-containing fuel. The oxygen-containing fuel is then added from the EHD atomizer 32 to the NOx storing and reducing catalyst 24 by the pulse application injection or the superimposed application injection.

As mentioned above, when the pulse application injection or the superimposed application injection is performed, hydrogen is generated. However, this hydrogen is the one released from the fuel (hydrocarbon), and thus, a particle mainly comprised a carbon atom may be generated in the fuel. If this carbon particle adheres on the inner wall surface of the narrow pipe 34 to form a deposit, the narrow pipe 34 may be clogged, and if it adheres on the NOx storing and reducing catalyst 24 to form a deposit, the exhaust purification action of the NOx storing and reducing catalyst 24 may be decreased.

Therefore, according to the fifth embodiment of the present invention, an oxygen containing fuel is formed, and the oxygen containing fuel is added to the NOx storing and reducing catalyst 24 by the pulse application injection or the superimposed application injection. Namely, when an oxygen mixed fuel is subjected to the pulse application injection or the superimposed application injection, the oxygen in the oxygen-mixed fuel reacts with a carbon atom or hydrocarbon to thereby suppress the generation of the carbon particle or the deposit. Accordingly, clogging of the narrow pipe 34 is suppressed, and a good exhaust purification action of the NOx storing and reducing catalyst 24 can be maintained.

Further, the reaction of oxygen with a carbon atom or hydrocarbon generates carbon monoxide. Carbon monoxide has a strong reduction ability, and accordingly, can promote the NOx release action of the NOx storing and reducing catalyst 24.

Alternatively, a fuel (hydrocarbon) may contain oxygen alone or an oxygen containing substance in place of air to form the oxygen containing fuel.

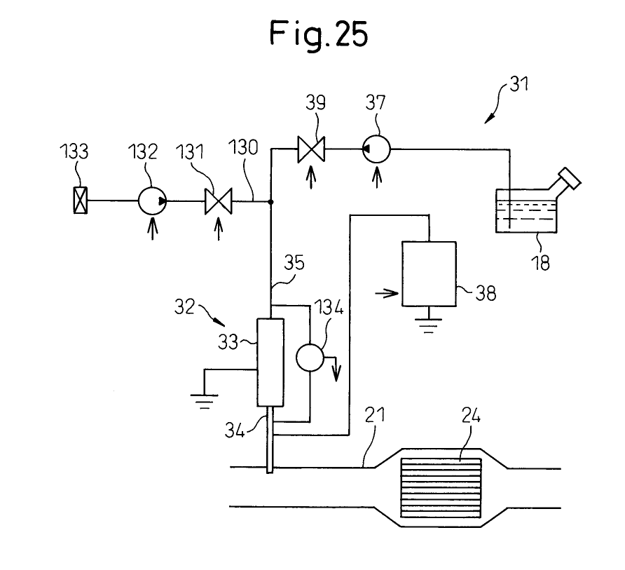

Next, a sixth embodiment of the present invention will be explained with reference to FIG. 25.

Referring to FIG. 25, an air introducing pipe 130 is connected to the fuel introducing pipe 35 located between the open/close valve 39 and the EHD atomizer 32, and an electronically-controlled open/close valve 131, an electronically-controlled air pump 132 and an air cleaner 133 are arranged in the air introducing pipe 35. Also, a pressure difference sensor 134 for detecting a pressure difference ΔP between the upstream side and the downstream side of the EHD atomizer 32 is provided.

When the fuel is to be supplied to the EHD atomizer 32, the open/close valve 131 is closed and the open/close valve 39 is opened to operate the fuel pump 37. In contrast, when the air which contains substantially no fuel is to be supplied to the EHD atomizer 32, the open/close valve 39 is closed and the open/close valve 131 is opened to operate the air pump 132.

As mentioned above, when the pulse application injection or the superimposed application injection is performed, the deposit may be formed on the inner wall surface of the narrow pipe 34 of the EHD atomizer 32. On the other hand, when air is flown through the EHD atomizer 32 and the pulse voltage is applied at that time, oxidizing gas such as ozone or oxygen radical is generated from the oxygen in the air, and the oxidizing gas can oxidize and remove the deposit on the inner wall surface of the narrow pipe 34.

Therefore, according to the sixth embodiment of the present invention, when a large amount of deposit is adhered on the inner wall surface of the narrow pipe 34, the fuel supply is stopped, the air is flown through the EHD atomizer 32, and the pulse voltage is applied at this time. As a result, the narrow pipe 34 can be prevented from being clogged.

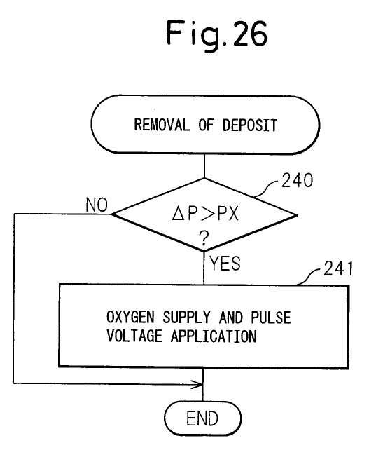

FIG. 26 shows a deposit removal control routine according to the sixth embodiment of the present invention. This routine is performed by interrupting at every previously determined set time.

Referring to FIG. 26, at first, whether or not the pressure difference ΔP is greater than the allowable value PX is judged in Step 240. In the case of ΔP≦PX, it is judged that the amount of deposit on the inner wall surface of the narrow pipe 34 is smaller than the allowable amount, and the processing cycle is terminated. In contrast, in the case of ΔP>PX, it is judged that the amount of deposit is greater than the allowable amount, and the process proceeds to the subsequent Step 241 to supply air to the EHD atomizer 32 and apply the pulse voltage.

Alternatively, in place of air, oxygen alone or the oxygen containing substance may be flown through the EHD atomizer 32 and the pulse voltage may be applied.

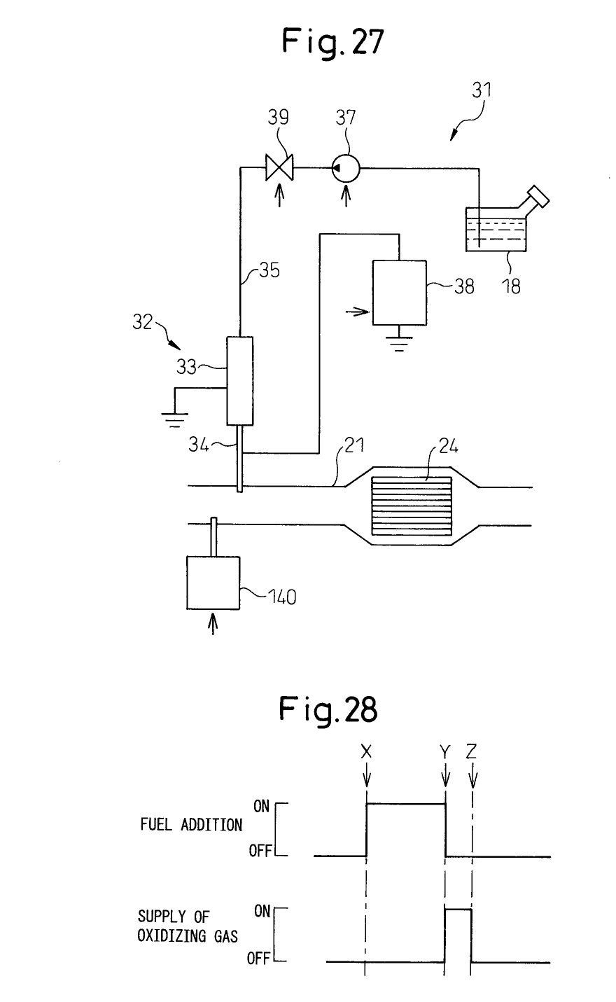

Next, a seventh embodiment of the present invention will be explained with reference to FIG. 27.

Referring to FIG. 27, an oxidizing gas generating and supplying device 140 is connected to the portion of the exhaust pipe 21 on the upstream side of the NOx storing and reducing catalyst 24. The oxidizing gas generating and supplying device 140 generates oxidizing gas such as ozone or oxygen radical from oxygen in the air by, for example, silent discharge or ultraviolet irradiation, and supplies the oxidizing gas to the exhaust pipe 21.

As mentioned above, when the pulse application injection or the superimposed application injection is performed, the deposit may be formed on the NOx storing and reducing catalyst 24. On the other hand, when the oxidizing gas is supplied to the NOx storing and reducing catalyst 24, the deposit on the NOx storing and reducing catalyst 24 is oxidized and removed by the oxidizing gas.

Thus, in the seventh embodiment of the present invention, oxidizing gas is supplied to the NOx storing and reducing catalyst 24 to oxidize and remove the deposit on the NOx storing and reducing catalyst 24. As a result, the decrease of the exhaust purification performance of the NOx storing and reducing catalyst 24 can be prevented.

It is considered that the timing for supplying the oxidizing gas can be set to a variety of timings. FIG. 28 shows the supply timing according to the seventh embodiment of the present invention. As shown by Y in FIG. 28, when the pulse application injection or the superimposed application injection from the EHD atomizer 32 is complete, the oxidizing gas supply is started. Then, for example, after a certain period of time has passed, as shown by Z in FIG. 28, the oxidizing gas supply is stopped. Alternatively, it is possible to detect the amount of deposit on the NOx storing and reducing catalyst 24, and to supply the oxidizing gas when the amount of the deposit exceeds the allowable amount.

In addition, as shown in FIG. 27, when the oxidizing gas generating and supplying device 140 is connected to the portion of the exhaust pipe 21 on the upstream side of the EHD atomizer 32, the oxidizing gas can also contact the narrow pipe 34 of the EHD atomizer 32, and thus, the deposit on the narrow pipe 34 can be oxidized and removed.

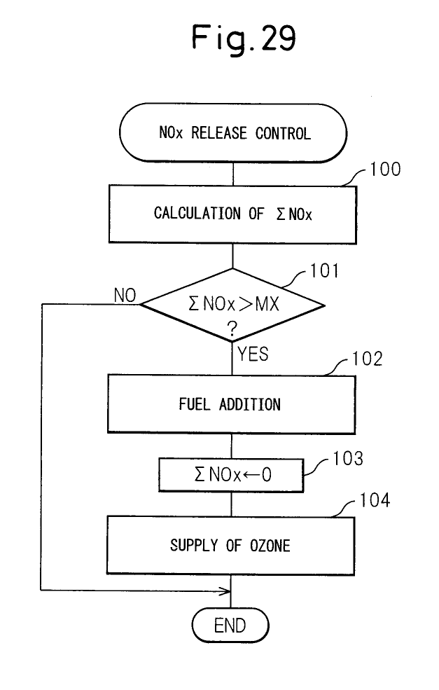

FIG. 29 shows an NOx release control routine according to the seventh embodiment of the present invention. This routine is performed by interrupting at every previously determined set time.

Referring to FIG. 29, at first, the NOx amount cumulative value ΣNOx (ΣNOx=ΣNOx+dNOx) is calculated in Step 200. In the subsequent Step 201, whether or not the NOx amount cumulative value ΣNOx exceeds the allowable value MX is judged. In the case of ΣNOx≦MX, the processing cycle is terminated. In the case of ΣNOx>MX, the process proceeds to Step 202, and the fuel addition is carried out by performing the pulse application injection or the superimposed application injection at the EHD atomizer 32. In the subsequent Step 203, the NOx amount cumulative value ΣNOx is cleared (ΣNOx=0). In the subsequent Step 204, oxidizing gas, for example, ozone is supplied from the oxidizing gas supplying device 140.

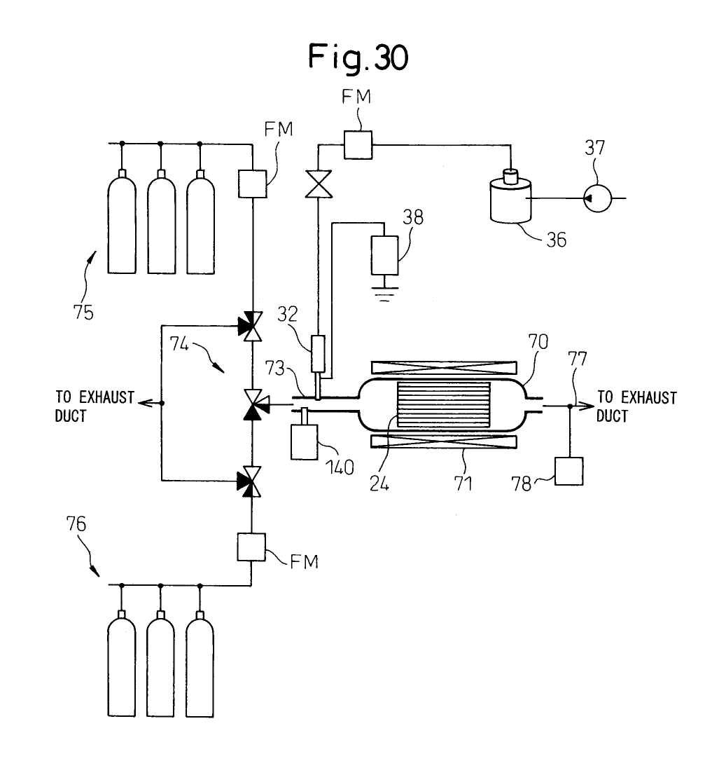

Suppression of decrease of the exhaust purification performance of the NOx storing and reducing catalyst 24 by the oxidizing gas is supported by the experiment. FIG. 30 shows the equipment used for the experiment. The configuration of this experimental equipment is different from the configuration of the experimental equipment of FIG. 13 in that the oxidizing gas generating and supplying device 140 is connected to the introducing pipe 73.

After the pretreatment, the simulated lean gas was supplied until the NOx storing and reducing catalyst 24 was saturated, while no oxidizing gas was supplied, and then, the simulated rich gas was supplied for 30 seconds to complete one cycle. The storage NOx amount SNOx after performing 100 cycles was obtained. Also, the simulated lean gas was supplied until the NOx storing and reducing catalyst 24 was saturated, and then, the simulated rich gas was supplied for 30 seconds, and thereafter, the oxidizing gas was supplied for one minute together with the simulated lean gas to complete one cycle. The storage NOx amount SNOx after performing 100 cycles was obtained. In both cases, at the time when the simulated rich gas was supplied, the superimposed application injection was performed. Also, at the time when the oxidizing gas was supplied, oxygen was supplied at 1 liter/min to the ozonizer of the oxidizing gas generating and supplying device 140, electric discharge was performed at the primary voltage of 50V, and ozone was generated at 5 g/h and supplied to the simulated lean gas. In this case, the ozone concentration in the simulated lean gas was approximately 2600 ppm. Other experimental conditions, such as the compositions of the simulated lean gas and the simulated rich gas were the same as those explained with reference to FIG. 13.

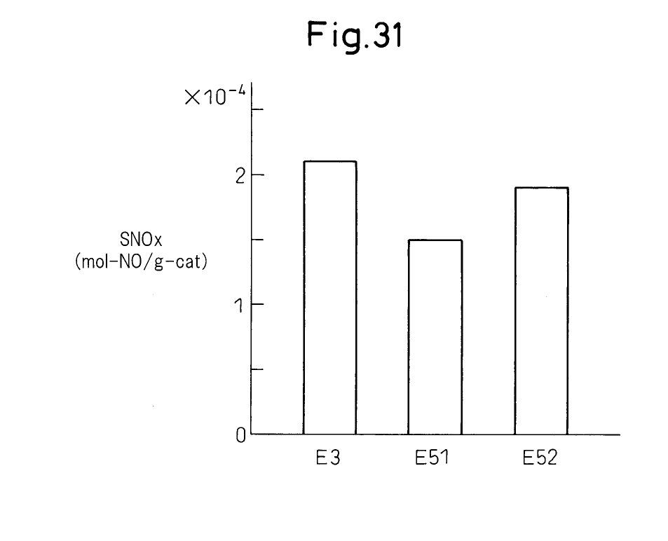

FIG. 31 shows the experimental results of the storage NOx amount SNOx. In FIG. 31, E3 shows the case that the simulated lean gas was supplied, and then, the simulated rich gas was supplied similar to the case shown in FIG. 14, namely, 1 cycle was carried out while no oxidizing gas was supplied, E51 shows the case that 100 cycles were performed while no oxidizing gas was supplied, and E52 shows the case that the 100 cycles were performed while the oxidizing gas was supplied, respectively. As shown in FIG. 31, when the oxidizing gas was not supplied, compared to the case having smaller number of cycles (E3), the case having larger number of cycles (E51) has less storage NOx amount SNOx, which results in the deterioration of the exhaust purification performance of the NOx storing and reducing catalyst 24. In contrast, when the oxidizing gas is supplied (E52), the deterioration of the exhaust purification performance of the NOx storing and reducing catalyst 24 can be suppressed.

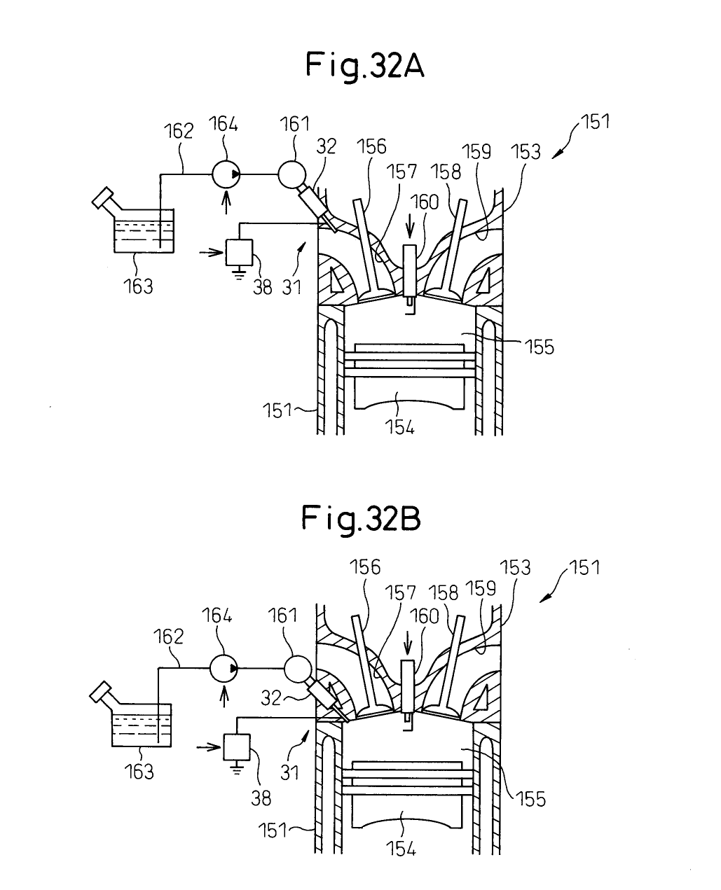

FIGS. 32A and 32B show the application of the present invention for supplying the fuel into the combustion chamber of the internal combustion engine. Referring to FIGS. 32A and 32B, 151 represents an engine body, 152 represents a cylinder block, 153 represents a cylinder head, 154 represents a piston, 155 represents a combustion chamber, 156 represents an intake valve, 157 represents an intake port, 158 represents an exhaust valve, 159 represents an exhaust port, and 160 represents an igniter plug, respectively. The EHD atomizers 32 of the respective cylinders are connected to a common delivery pipe 161, the delivery pipe 161 is connected through a fuel introducing pipe 162 to a fuel tank 163, and a fuel pump 164 is arranged in the fuel introducing pipe 162.

In the example shown in FIG. 32A, the fuel is injected from the fuel injection apparatus 31 into the intake port 157, namely, the intake passage. In the example shown in FIG. 32B, the fuel is directly injected from the fuel injection apparatus 31 into the combustion chamber 155.

### LIST OF REFERENCE NUMERALS

1 . . . ENGINE BODY
21 . . . EXHAUST PIPE
24 . . . NOx STORING AND REDUCING CATALYST
31 . . . FUEL INJECTION APPARATUS
32 . . . EHD ATOMIZER
34 . . . NARROW PIPE
35 . . . FUEL INTRODUCING PIPE
36 . . . FUEL TANK
38 . . . VOLTAGE APPLICATION DEVICE

1. A fuel injection apparatus which, in order to supply fuel to a catalyst arranged in an exhaust passage of an internal combustion engine, injects fuel to the exhaust passage upstream of the catalyst, the apparatus comprising a fuel injection pipe to which a voltage apply means is connected, wherein fuel is flowed through the fuel injection pipe while a pulse voltage is applied to the fuel injection pipe, to thereby inject the fuel while the pulse voltage is applied to the fuel.

2. A fuel injection apparatus according to claim 1, wherein it is performed a superimposed application injection in which fuel is injected while a pulse voltage and direct-current voltage to the fuel are superimposingly applied to the fuel.

3. A fuel injection apparatus according to claim 1, wherein a pulse application injection in which fuel is injected while only a pulse voltage is applied to the fuel, and a direct current application injection in which fuel is injected while only a direct-current voltage is applied to the fuel, are selectively switched.

4. A fuel injection apparatus according to claim 1, wherein a pulse application injection in which fuel is injected while only a pulse voltage is applied to the fuel, and a non-application injection in which fuel is injected while no voltage is applied to the fuel, are selectively switched.

5. A fuel injection apparatus according to claim 2, wherein the superimposed application injection and a pulse application injection in which fuel is injected while only a pulse voltage is applied to the fuel, are selectively switched.

6. A fuel injection apparatus according to claim 2, wherein the superimposed application injection and a direct current application injection in which fuel is injected while only a direct-current voltage is applied to the fuel, are selectively switched.

7. A fuel injection apparatus according to claim 2, wherein the superimposed application injection and a non-application injection in which fuel is injected while no voltage is applied to the fuel, are selectively switched.

8. A fuel injection apparatus according to claim 1, wherein the fuel injection mode is selectively switched depending on the state quantity of a fuel supply destination.

9. A fuel injection apparatus according to claim 1, wherein at least a part of fuel flown through the fuel injection pipe while the voltage is applied to the fuel is stored in a storage chamber, and the fuel in the storage chamber is injected.

10. A fuel injection apparatus according to claim 9, wherein fuel flown through the fuel injection pipe and the fuel in the storage chamber are selectively injected.

11. A fuel injection apparatus according to claim 9, comprising a plurality of storage chambers, wherein at least a part of fuel flown through the fuel injection pipe while the voltage is applied to the fuel is separated and stored in the respective corresponding storage chambers depending on the properties of the fuel, and the fuels in the storage chambers are respectively injected.

12. A fuel injection apparatus according to claim 11, wherein at least one of the fuels consisting of the fuel flown through the fuel injection pipe and the fuels in the plurality of storage chambers is selectively injected.

13. A fuel injection apparatus according to claim 1, wherein at least a part of the fuel flown through the fuel injection pipe while the voltage is applied to the fuel is flown again through the fuel injection pipe while the voltage is applied to the fuel, and is injected.

14. A fuel injection apparatus according to claim 1, wherein an oxygen containing fuel which contains oxygen or an oxygen containing substance is formed, and wherein the oxygen containing fuel is flown through the fuel injection pipe while a pulse voltage is applied to the fuel injection pipe, to thereby inject the oxygen containing fuel while the pulse voltage is applied to the oxygen containing fuel.

15. A fuel injection apparatus according to claim 1, wherein oxygen or oxygen containing substance is flowed through the fuel injection pipe while the flow of fuel through the fuel injection pipe is stopped and the pulse voltage is applied to the fuel injection pipe, to thereby inject the oxygen or oxygen containing substance while the pulse voltage is applied to the oxygen or the oxygen containing substance.

16. A fuel injection apparatus according to claim 1, comprising an oxidizing gas supply means for supplying an oxidizing gas, wherein the oxidizing gas is supplied to a fuel supply destination from the oxidizing gas supply means after the fuel injection by the fuel injection apparatus.

17. A fuel injection apparatus which injects fuel into an intake passage or a combustion chamber of an internal combustion engine, the apparatus comprising a fuel injection pipe to which a voltage apply means is connected, wherein fuel is flowed through the fuel injection pipe while a pulse voltage is applied to the fuel injection pipe, to thereby inject the fuel while the pulse voltage is applied to the fuel.

18. (canceled)

19. A fuel injection apparatus according to claim 1, wherein the catalyst comprises an NOx absorbent which absorbs NOx in an exhaust gas when an air-fuel ratio of the inflowing exhaust gas is lean, and releases the absorbed NOx when the air-fuel ratio of the inflowing exhaust gas is rich, and wherein, when the NOx is to be released from the NOx absorbent, fuel is injected from the fuel injection apparatus to temporally make the air-fuel ratio of the exhaust gas flowing into the NOx absorbent rich.

20. An exhaust gas purification apparatus for an internal combustion engine, comprising:
an NOx absorbent arranged in an engine exhaust passage, the NOx absorbent absorbing NOx in an exhaust gas when an air-fuel ratio of the inflowing exhaust gas is lean and releasing the absorbed NOx when the air-fuel ratio of the inflowing exhaust gas is rich; and
an fuel injection device arranged in the engine exhaust passage on the upstream side of the NOx absorbent, from which fuel is injected to temporally make the air-fuel ratio of the exhaust gas flowing into the NOx absorbent rich when NOx is to be released from the NOx absorbent,
wherein the fuel injection device comprises a fuel injection pipe to which a voltage application means is connected, and wherein fuel is flown through the fuel injection pipe while a pulse voltage is applied to the fuel injection pipe to thereby inject the fuel while the pulse voltage is applied to the fuel.

21. An exhaust purification apparatus for an internal combustion engine according to claim 20, wherein the temperature of the NOx absorbent is detected, and wherein a pulse application injection in which fuel is injected while only a pulse voltage is applied to the fuel, and a direct current application injection in which fuel is injected while only a direct-current voltage is applied to the fuel, are selectively switched depending on the temperature of the NOx absorbent.

22. An exhaust purification apparatus of an internal combustion engine according to claim 20, wherein the temperature of the NOx absorbent is detected, and wherein a pulse application injection in which fuel is injected while only a pulse voltage is applied to the fuel, and a non-application injection in which fuel is injected while no voltage is applied to the fuel, are selectively switched depending on the temperature of the NOx absorbent.

23. An exhaust purification apparatus for an internal combustion engine according to claim 20, wherein the temperature of the NOx absorbent is detected, and wherein a superimposed application injection in which fuel is injected while a pulse voltage and direct-current voltage to the fuel are superimposingly applied to the fuel and a pulse application injection in which fuel is injected while only a pulse voltage is applied to the fuel, are selectively switched depending on the temperature of the NOx absorbent.

24. An exhaust purification apparatus for an internal combustion engine according to claim 20, wherein the temperature of the NOx absorbent is detected, and wherein a superimposed application injection in which fuel is injected while a pulse voltage and direct-current voltage to the fuel are superimposingly applied to the fuel and a direct current application injection in which fuel is injected while only a direct-current voltage is applied to the fuel, are selectively switched depending on the temperature of the NOx absorbent.

25. An exhaust purification apparatus for an internal combustion engine according to claim 20, wherein the temperature of the NOx absorbent is detected, and wherein a superimposed application injection in which fuel is injected while a pulse voltage and direct-current voltage to the fuel are superimposingly applied to the fuel and a non-application injection in which fuel is injected while no voltage is applied to the fuel, are selectively switched depending on the temperature of the NOx absorbent.
